(19) United States
(12) Patent Application Publication
(10) Pub. No.: US 2025/0329736 A1
(43) Pub. Date: Oct. 23, 2025

(54) ANODE FOR SODIUM ION BATTERIES COMPRISING HARD CARBON, AND METHOD OF MANUFACTURING SAME

(71) Applicants: INHA UNIVERSITY RESEARCH AND BUSINESS FOUNDATION, Incheon (KR); KOREA UNIVERSITY RESEARCH AND BUSINESS FOUNDATION, Seoul (KR)

(72) Inventors: Hyoung-Joon JIN, Seoul (KR); Jong Chan HYUN, Seoul (KR); Young Soo YUN, Gyeonggi-do (KR)

(73) Assignees: INHA UNIVERSITY RESEARCH AND BUSINESS FOUNDATION, Incheon (KR); KOREA UNIVERSITY RESEARCH AND BUSINESS FOUNDATION, Seoul (KR)

(21) Appl. No.: 19/056,827

(22) Filed: Feb. 19, 2025

(30) Foreign Application Priority Data
Apr. 23, 2024 (KR) 1020240054095

(51) Int. Cl. H01M 4/587; C01B 32/324; C01B 32/348; H01M 4/02; H01M 10/054

(52) U.S. Cl. CPC H01M 4/587; C01B 32/324; C01B 32/348; H01M 10/054; C01P 2002/60; C01P 2002/72; C01P 2002/74; C01P 2002/82; C01P 2002/85; C01P 2002/88; C01P 2004/02; C01P 2004/03; C01P 2004/04; C01P 2006/17; C01P 2006/40; H01M 2004/021

(57) ABSTRACT

The present disclosure relates to anode for sodium ion batteries including hard carbon, and method of manufacturing the same. According to anode for sodium ion batteries including hard carbon, and method of manufacturing the same according to an embodiment of the present disclosure, it is possible to achieve improved reversible capacity and balanced electrochemical performance through an SPC factor, which is a structural index.

### DESCRIPTION OF GOVERNMENT-SPONSORED RESEARCH

This invention was carried out with the support of the Ministry of Science and ICT under a research project of Unique Project identification number: 1711184732 and Project identification number: 2021R1A4A2001403 titled “Lab for Standard Carbon Model Design”, as part of the research project of “Support for Group Research” managed by the National Research Foundation of Korea from Mar. 1, 2023 to Feb. 29, 2024.

This invention was carried out with the support of the Ministry of Science and ICT under a research project of Unique Project identification number: 1711199395 and Project identification number: 00302689 titled “Development of aqueous lithium metal hybrid capacitors through controlling electrochemical double layers of complex systems”, as part of the research project of “Pioneer Business of Future Prominent Fusion Technology” managed by the National Research Foundation of Korea from Aug. 1, 2023 to Dec. 31, 2028.

### CROSS REFERENCE TO RELATED APPLICATION

The present application claims priority to Korean Patent Application No. 10-2024-0054095, filed on Apr. 23, 2024, the entire contents of which is incorporated herein for all purposes by this reference.

### BACKGROUND OF THE INVENTION

### Field of the Invention

Disclosed herein are an anode for sodium ion batteries comprising hard carbon, and a method of manufacturing the same.

### Description of the Related Art

In the construction of anode for sodium ion batteries, unclear information about the material design is problematic. The pore volume ratio of the anode material imposes a thermodynamic limitation on the theoretical value of the sodium plateau capacities (SPCs) (T-SPCs), but the pore volume ratio alone is not sufficient to predict the actual sodium plateau capacities (SPCs). Sodium-ion batteries (SIBs) are based on abundant sodium resources on Earth and feasible chemistry compatible with well-established lithium-ion battery (LIB) technology. Sodium-ion batteries (SIBs) have significant potential in key applications of Industry 4.0, such as electric vehicles, Urban Air Mobility (UAM), humanoid robots, and large-scale energy storage systems. However, the poor energy density of sodium-ion batteries (SIBs) has remained a major barrier to penetration into the dominant lithium-ion battery (LIB) market. Accordingly, potential candidates for feasible anode materials have been extensively explored over the past decade. Korean Patent Registration Gazette No. 10-2206032 discloses a tin-based negative electrode active material for sodium secondary batteries. Nevertheless, competitive active anode materials for sodium-ion batteries (SIBs) that may counteract the electrochemical performance of lithium-ion battery (LIB) compounds have not yet been realized.

### SUMMARY OF THE INVENTION

It is an object of an aspect of the present disclosure to provide material design guidelines for high performance anode for sodium ion batteries (SIBs).

In an aspect of the present disclosure, the present disclosure provides a method of manufacturing anode for sodium ion batteries, comprising thermally oxidizing a hard carbon precursor at a temperature of 250 to 400° C. to obtain a microstructured hard carbon, and heating the microstructured hard carbon at a temperature of 2000 to 3000° C. to obtain polymeric hard carbons.

In an aspect of the present disclosure, the present disclosure provides an anode for sodium ion batteries, manufactured by the method of manufacturing anode for sodium ion batteries, comprising: polymeric hard carbons, wherein an SPC factor of the polymeric hard carbons represented by the following equation 1 is 0.5 to 1, 0.65 to 1, or 0.7 to 0.85.

$$SPC factor = ( 1 - Pore volume ratio \times \frac{{I}_{2 D}}{{I}_{G}} ) \qquad [ Equation 1 ]$$

According to anode for sodium ion batteries comprising hard carbon, and method of manufacturing the same according to an embodiment of the present disclosure, it is possible to achieve improved reversible capacity and balanced electrochemical performance through an SPC factor, which is a structural index.

### BRIEF DESCRIPTION OF THE DRAWINGS

FIG. 1 is a graph showing a gel permeation chromatography (GPC) curve of hard carbon according to an embodiment of the present disclosure.

FIG. 2 is a graph showing a Fourier transform infrared (FT-IR) spectroscopy spectrum curve of hard carbon according to an embodiment of the present disclosure.

FIGS. 3A and 3B are graph showing an X-ray photoelectron spectroscopy (XPS) curve of hard carbon according to an embodiment of the present disclosure.

FIG. 4 is an optical image of hard carbon according to an embodiment of the present disclosure.

FIG. 5 is a graph showing a thermogravimetric analysis (TGA) curve and a differential scanning calorimetry (DSC) curve of hard carbon according to an embodiment of the present disclosure.

FIG. 6 is a graph showing an X-ray diffraction (XRD) curve of hard carbon according to an embodiment of the present disclosure.

FIG. 7 is a graph showing a Raman spectrum curve of hard carbon according to an embodiment of the present disclosure.

FIGS. 8A to 8D are transmission electron microscope image of hard carbon according to an embodiment of the present disclosure.

FIG. 9 is a graph showing the crystal size (La) curve along the a-axis of hard carbon according to an embodiment of the present disclosure.

FIG. 10 is a graph showing the crystal size (Lc) curve along the c-axis of hard carbon according to an embodiment of the present disclosure.

FIG. 11 is a graph showing a d-spacing curve of hard carbon according to an embodiment of the present disclosure.

FIG. 12 is a graph showing an average pore diameter curve of hard carbon according to an embodiment of the present disclosure.

FIG. 13 is a graph showing a particle density curve of hard carbon according to an embodiment of the present disclosure.

FIG. 14 is a graph showing a pore volume ratio curve of hard carbon according to an embodiment of the present disclosure.

FIG. 15 is a graph showing an SPC capacity curve of hard carbon according to an embodiment of the present disclosure.

FIG. 16 is a graph showing a coefficient of capacity utilization (CCU) curve of hard carbon according to an embodiment of the present disclosure.

FIGS. 17A to 17D are graph showing the Raman spectrum curve of hard carbon according to an embodiment of the present disclosure.

FIGS. 18A to 18D are graph showing a peak intensity ratio (I_{2D}/I_{G}) value of a 2D band to a G band and a charge-transfer resistance value of hard carbon according to an embodiment of the present disclosure.

FIGS. 19A and 19B are graph showing the coefficient of capacity utilization (CCU) and a SPC factor curve of hard carbon according to an embodiment of the present disclosure.

FIGS. 20A and 20B are graph showing the coefficient of capacity utilization (CCU) and the SPC factor curve of hard carbon according to an embodiment of the present disclosure.

FIG. 21 is a graph showing a constant-current discharge/charge profile curve of hard carbon according to an embodiment of the present disclosure.

FIG. 22 is a graph showing the SPC capacity of hard carbon according to an embodiment of the present disclosure.

FIG. 23 is a graph showing the peak intensity ratio (I_{2D}/I_{G}) value of the 2D band to the G band and the pore volume ratio of hard carbon according to an embodiment of the present disclosure.

FIG. 24 is a graph showing the SPC factor and the charge-transfer resistance value of hard carbon according to an embodiment of the present disclosure.

FIG. 25 is a graph showing the coefficient of capacity utilization (CCU) and the SPC factor curve of hard carbon according to an embodiment of the present disclosure.

FIG. 26 is the transmission electron microscope image of hard carbon according to an embodiment of the present disclosure.

FIG. 27 is a scanning electron microscope image of hard carbon according to an embodiment of the present disclosure.

FIG. 28 is a graph showing the X-ray diffraction (XRD) curve of hard carbon according to an embodiment of the present disclosure.

FIG. 29 is a graph showing the Raman spectrum curve of hard carbon according to an embodiment of the present disclosure.

FIGS. 30A and 30B are graph showing a constant-current sodiation/lithiation profile curve of hard carbon according to an embodiment of the present disclosure.

FIG. 31 is a graph showing a volume expansion curve according to a process of sodiation/lithiation of hard carbon according to an embodiment of the present disclosure.

FIG. 32 is a graph showing specific capacity and voltage of hard carbon according to an embodiment of the present disclosure.

### DETAILED DESCRIPTION OF THE INVENTION

Hereinafter, preferred embodiments of the present disclosure will be described in detail with reference to the accompanying drawings.

The embodiments of the disclosure disclosed herein are illustrated for illustrative purposes only, and the embodiments of the disclosure may be embodied in various forms and should not be construed as limited to the embodiments as described herein. While the present disclosure is subject to various modifications and may take on a variety of forms, it is to be understood that the embodiments are not intended to limit the disclosure to the particular forms disclosed, but to include all modifications, equivalents, and substitutions that fall within the spirit and scope of the present invention.

In this specification, when a part “comprises” a component, it means that, unless explicitly specified otherwise, the part may further include other components instead of excluding the other components.

The same reference numerals refer to similar parts throughout the specification. Throughout the specification, when portions such as layers, films, regions, plates, or the like are referred to as being “on” or “over” another portion, this includes not only the case where the portion is directly on the other portion but also the case where there is another portion therebetween. Although terms such as first and second may be used throughout the specification to describe various components, the components should not be limited by the terms. The terms are only used for the purpose of distinguishing one component from another.

### Method of Manufacturing Anode for Sodium Ion Batteries

In an aspect of the present disclosure, the present disclosure provides a method of manufacturing anode for sodium ion batteries, comprising thermally oxidizing a hard carbon precursor at a temperature of 250 to 400° C. to obtain a microstructured hard carbon, and heating the microstructured hard carbon at a temperature of 2000 to 3000° C. to obtain polymeric hard carbons.

The thermal oxidation step is a step for transforming the macromolecular structure of the hard carbon precursor. The thermal oxidation step is a key step in controlling the microstructure of the hard carbon, and as the oxidation temperature increases, the main chain of the hard carbon precursor decomposes, resulting in a decrease in the number-average molecular weight (Mn).

The heating step is a step for transitioning the microstructure of the hard carbon to obtain the polymeric hard carbons, and as the heating temperature increases, the microstructure transitions, resulting in the further development of polyhexagonal carbon regions with the sp² structure and an increase in the average pore diameter. In addition, as the heating temperature increases, the d-spacing of the graphite lattice in the hard carbon decreases, indicating that the graphite structure continuously develops into a denser structure as the heating temperature is increased, and that the densification becomes more pronounced as the oxidation temperature is increased.

In one embodiment, the thermal oxidation temperature of the hard carbon precursor is 250 to 400° C. More specifically, the thermal oxidation temperature may be, but is not limited to, 250° C. or higher, 260° C. or higher, 270° C. or higher, 280° C. or higher, 290° C. or higher, 300° C. or higher, 310° C. or higher, 320° C. or higher; 400° C. or lower, 390° C. or lower, 380° C. or lower, 370° C. or lower, 360° C. or lower, 350° C. or lower, 340° C. or lower, 330° C. or lower, or 320° C. or lower.

In one embodiment, the heating temperature of the hard carbon with the microstructure is from 2000 to 3000° C. More specifically, the heating temperature may be, but is not limited to, 2000° C. or higher, 2100° C. or higher, 2200° C. or higher, 2300° C. or higher, 2400° C. or higher; 3000° C. or lower, 2900° C. or lower, 2800° C. or lower, 2700° C. or lower, 2600° C. or lower, 2500° C. or lower, 2400° C. or lower.

In one embodiment, the method further includes performing chemical activation of the polymeric hard carbon. The controlled chemical activation increases the pore volume ratio and at the same time reduces the local graphite order. The chemical activation mechanism using potassium hydroxide proceeds in two steps: a first carbon etching step based on steam, and a second carbon etching step using metallic potassium. Defective carbon structures may be removed primarily with CO or CO₂ during the first etching process, which increases the relative proportion of aligned graphite regions and the relative G band intensity. The second etching process produces metallic potassium at a higher activation temperature of 700° C. or higher, which may be intercalated into the aligned graphite lattice. The graphite layer in which potassium is intercalated is greatly expanded to 5 Å or more, thereby activating the internal graphite region for the carbon etching process. As a result, dense graphite structures may be damaged and loosened by strong carbon etching and metallic potassium insertion/removal processes. In addition, strong chemical etching may remove internal carbon components and increase the closed pore volume ratio, thereby greatly improving the SPC factor.

In one embodiment, the activator used for chemical activation is any one selected from the group consisting of sodium hydroxide, lithium hydroxide, potassium hydroxide, rubidium hydroxide, cesium hydroxide, magnesium hydroxide, calcium hydroxide, strontium hydroxide and barium hydroxide.

In one embodiment, the content of the activator is from 10 to 50 wt % based on the weight of the polymeric hard carbon. More specifically, the content of the activator may be, but is not limited to, 10 wt % or more, 15 wt % or more, 20 wt % or more, 25 wt % or more, 30 wt % or more; 50 wt % or less, 45 wt % or less, 40 wt % or less, 35 wt % or less, 30 wt % or less, based on the weight of the polymeric hard carbons. Controlling the content of the activator serves as an important role in the adjustment of the microstructure. In relatively mild chemical activation processes with low activator content, the relative G band intensity may be increased by removing defective carbon structures. However, the local graphite arrangement is not affected by this process and maintains the original 2D band intensity. In contrast, a strong chemical activation process using more activator may attack aligned domains.

### Anode for Sodium Ion Batteries

In an aspect of the present disclosure, the present disclosure provides an anode for sodium ion batteries, manufactured by the method of manufacturing anode for sodium ion batteries, comprising: polymeric hard carbons, wherein an SPC factor of the polymeric hard carbons represented by the following equation 1 is 0.5 to 1.

$$SPC factor = ( 1 - Pore volume ratio \times \frac{{I}_{2 D}}{{I}_{G}} ) \qquad [ Equation 1 ]$$

In the above equation 1, the pore volume ratio is the volume ratio of closed pores, and the peak intensity ratio (I_{2D}/I_{G}) of the 2D band to the G band is the peak intensity ratio of the 2D band (near 2690 cm⁻¹) to the G band (near 1580 cm⁻¹) as measured by Raman spectroscopy.

The inventors investigated the key kinetic parameters of hard carbons that affect the coefficient of capacity utilization (CCU) of sodium plateau capacities (SPCs) for a series of polymeric hard carbons (PHCs) with different microstructures. A systematic study revealed a close relationship between the peak intensity ratio (I_{2D}/I_{G}) of the 2D band to the G band as measured by Raman spectroscopy and the internal kinetic barrier for sodium ion transfer. The inventors have discovered a structural index called SPC factor based on thermodynamic and kinematic parameters. The SPC factor characterizes the coefficient of capacity utilization (CCU) for sodium plateau capacities (SPCs). The SPC factor clearly explains that an anode with a high pore volume ratio and a low peak intensity ratio (I_{2D}/I_{G}) value of 2D band to G band is the optimal hard carbon anode.

Hard carbon is a disordered graphitic carbon which is inexpensive and has a simple manufacturing process and balanced electrochemical properties. The sodium ion storage profile of hard carbon under constant-current conditions exhibits long-term sodium plateau capacity (SPC). The low-voltage sodium ion storage mechanism is a mechanism of filling nanopores, which is distinctly distinct from the inter-layer reaction mechanism. Thus, nanoscale closed pores are considered a key factor affecting the sodium plateau capacity (SPC) of hard carbon anodes. However, due to the complex and entangled microstructure of hard carbon composed of numerous disordered graphite lattices, it is not possible to use a substantial amount of closed pores even in the fully sodiated state. This results in an insufficient and extensive sodium plateau capacity (SPC).

The types of pores of porous solids are broadly classified into through pores, blind pores, interconnected pores, and closed pores. The closed pores are a cavity that is not connected to the surface, and the blind pores have a single connection to the surface. The through pores have passages connected from one side to the other and the interconnected pores have the passages connected to each other. The pore volume ratio of the present disclosure is the volume ratio of closed pores.

In one embodiment, the SPC factor of the polymeric hard carbons is from 0.5 to 1. More specifically, the SPC factor of the polymeric hard carbons may be, but is not limited to, 0.5 or more, 0.6 or more, 0.65 or more, 0.69 or more, 0.7 or more, 0.73 or more, 0.74 or more, 0.75 or more, 0.76 or more; 1 or less, 0.95 or less, 0.94 or less, 0.9 or less, 0.87 or less, 0.85 or less, 0.82 or less, 0.81 or less, 0.8 or less, 0.76 or less.

In one embodiment, the pore volume ratio of the polymeric hard carbon is from 10 to 80%. More specifically, the pore volume ratio of the polymeric hard carbons may be, but is not limited to, 10% or more, 15% or more, 20% or more, 25% or more, 26% or more, 27% or more, 28% or more, 29% or more, 30% or more, 31% or more, 32% or more, 33% or more, 34% or more, 35% or more, 36% or more; 80% or less, 70% or less, 60% or less, 50% or less, 49% or less, 48% or less, 47% or less, 46% or less, 45% or less, 44% or less, 43% or less, 42% or less, 41% or less, 40% or less, 39% or less, 38% or less, 37% or less, 36% or less.

In one embodiment, the peak intensity ratio (I_{2D}/I_{G}) of the 2D band to the G band of the polymeric hard carbons is from 0.01 to 1. More specifically, the peak intensity ratio (I_{2D}/I_{G}) of the 2D band to the G band of the polymeric hard carbons may be, but is not limited to, 0.01 or more, 0.05 or more, 0.1 or more, 0.15 or more, 0.18 or more, 0.2 or more, 0.25 or more, 0.3 or more, 0.35 or more, 0.36 or more, 0.4 or more, 0.43 or more, 0.45 or more, 0.5 or more, 0.54 or more; 1 or less, 0.95 or less, 0.9 or less, 0.85 or less, 0.8 or less, 0.76 or less, 0.75 or less, 0.71 or less, 0.7 or less, 0.65 or less, 0.6 or less, 0.55 or less, 0.54 or less.

In an aspect of the present disclosure, when the method further includes the performing chemical activation of the polymeric hard carbons, the SPC factor of the polymeric hard carbons is 0.5 to 1. More specifically, the SPC factor of the polymeric hard carbons may be, but is not limited to, 0.5 or more, 0.6 or more, 0.65 or more, 0.69 or more, 0.7 or more, 0.73 or more, 0.74 or more, 0.75 or more, 0.76 or more; 1 or less, 0.95 or less, 0.94 or less, 0.9 or less, 0.87 or less, 0.85 or less, 0.82 or less, 0.81 or less, 0.8 or less, 0.76 or less.

In one embodiment, the pore volume ratio of the polymeric hard carbon is from 10 to 80%. More specifically, the pore volume ratio of the polymeric hard carbons may be, but is not limited to, 10% or more, 15% or more, 20% or more, 25% or more, 26% or more, 27% or more, 28% or more, 29% or more, 30% or more, 31% or more, 32% or more, 33% or more, 34% or more, 35% or more, 36% or more; 80% or less, 70% or less, 60% or less, 50% or less, 49% or less, 48% or less, 47% or less, 46% or less, 45% or less, 44% or less, 43% or less, 42% or less, 41% or less, 40% or less, 39% or less, 38% or less, 37% or less, 36% or less.

In one embodiment, the peak intensity ratio (I_{2D}/I_{G}) of the 2D band to the G band of the polymeric hard carbons is from 0.01 to 1. More specifically, the peak intensity ratio (I_{2D}/I_{G}) of the 2D band to the G band of the polymeric hard carbons may be, but is not limited to, 0.01 or more, 0.05 or more, 0.1 or more, 0.15 or more, 0.18 or more, 0.2 or more, 0.25 or more, 0.3 or more, 0.35 or more, 0.36 or more, 0.4 or more, 0.43 or more, 0.45 or more, 0.48 or more, 0.5 or more, 0.54 or more; 1 or less, 0.95 or less, 0.9 or less, 0.85 or less, 0.8 or less, 0.76 or less, 0.75 or less, 0.71 or less, 0.7 or less, 0.65 or less, 0.6 or less, 0.55 or less, 0.54 or less.

### Sodium Ion Batteries

In an aspect of the disclosure, the disclosure provides sodium ion batteries including anode for the sodium ion batteries.

In one embodiment, the operating temperature of the sodium ion batteries is 20° C. to 80° C. More specifically, the operating temperature of the sodium ion batteries may be, but is not limited to, 20° C. or higher, 25° C. or higher, 30° C. or higher, 35° C. or higher, 40° C. or higher, 45° C. or higher, 50° C. or higher, 55° C. or higher, 60° C. or higher; 80° C. or lower, 75° C. or lower, 70° C. or lower, 65° C. or lower, 60° C. or lower.

Hereinafter, the present disclosure will be described in detail with reference to preferred embodiments so that those skilled in the art to which the disclosure pertains may easily practice the disclosure. The disclosure may, however, be implemented in various different forms and should not be construed as limited to the embodiments described herein.

### <Preparation Example 1> Preparation of Anode for Sodium Ion Batteries (1. Thermal Oxidation Step)

5 g of a waste PET bottle washed several times with ethanol and distilled water was cut into small PET pieces of 3 cm×5 cm. The PET pieces, which are hard carbon precursors, were then performed thermal oxidation by heat treatment in a tubular furnace at temperatures of 280, 320, 350 and 380° C., respectively, for 30 minutes under an air flow rate of 100 mL/min. The names of the obtained samples were designated according to the thermal oxidation temperature (O280, O320, O350 and O380).

### <Preparation Example 2> Preparation of Anode for Sodium Ion Batteries (2. Heating Step)

The obtained sample was transferred to a graphite furnace and heated from room temperature to 1200, 1600, 2000, 2400 and 2800° C. under argon (Ar) atmosphere to obtain polymeric hard carbons. Different heating rates of 5, 3 and 2° C./min were applied for the temperature ranges from room temperature to 1600° C., 1600° C. to 2400° C., 2400° C. to 2800° C., respectively. The names of the obtained samples were designated according to the heating temperature (O280-1200, O280-1600 to O380-2400, and O380-2800).

### <Preparation Example 3> Preparation of Anode for Sodium Ion Batteries (3. Chemical Activation Step)

O280-2400 samples of the obtained series of polymeric hard carbon samples were washed several times with ethanol and distilled water and stored in a vacuum oven at 30° C. In addition, chemical activation was performed by mixing the O280-2400 sample and 10, 30 and 50 wt % of potassium hydroxide based on the weight of the O280-2400 sample in a mortar and then heating at 800° C. for 2 hours in the tubular furnace. The chemical activation process was applied with heating rate of 5° C./min and argon (Ar) flow of 150 mL/min. The names of the obtained samples were designated according to the content of potassium hydroxide (A10, A30 and A50).

### <Reference Example 1> Characterization

The morphology of the samples was characterized using transmission electron microscopy (TEM, JEM2100F, JEOL, Japan) and field emission scanning electron microscopy (FE-SEM, S-4300SE, Hitachi, Japan).

Raman spectroscopy was performed using Raman microscope (Renishaw InVia, Renishaw, UK) equipped with a laser of 514 nm wavelength, 0.15 mW power output, 1200 groove/mm grating. The spot size of the laser was focused through a 100× optical lens, and the exposure time was set to 10 seconds. The lateral size La of the polyhexagonal carbon planes in the Raman spectral analysis was calculated from the intensity ratio I_{D}/I_{G} of the D to G bands. When La exceeds 2 nm, the Tuinstra and Koenig relation I_{D}/I_{G}=(2)/La was used, where the constant C (2) was set to 4.4 for a 514 nm laser wavelength. When La is less than 2 nm, the Ferrari and Robertson relation I_{D}/I_{G}=C′(λ)/La² was used. The wavelength-dependent pre-factor C′(λ) was determined as C′(λ)=C₀+λC₁, where C₀ is −12.6 nm and C₁ is 0.033.

The microstructure of the samples was obtained from X-ray diffraction (XRD, Rigaku, DMAX 2500) performed using Cu-Kα radiation (λ=0.154 nm) at 40 kV and 100 mA in the 20 range from 5° to 60°.

The crystal thickness Lc of the sample was determined by applying the Scherrer relation Lc=Kλ/βcosθ (K represents the shape factor and is commonly 0.9, λ represents the X-ray source wavelength for Cu-Kα radiation (λ=0.154 nm), β represents the overall width in radians, and θ represents the diffraction angle).

The specific surface area of the samples was characterized by nitrogen adsorption and desorption isotherm analysis at 77K (ASAP2020, Micromeritics, USA).

The surface properties of the samples were measured by X-ray photoelectron spectroscopy (XPS, PHI 5700 ESCA, Chanhassen, USA) using monochromatic Al-Kα radiation.

Particle density was recorded on Pycnometer analyzer (AccuPyc 1330) using helium as the analysis gas.

The structure of the pores was obtained from small-angle X-ray scattering (SAXS) data collected using Lab-SAXS (Rigaku, NANOPIX) with Cu-Kα radiation with a distance of 330 mm from the sample to the detector (q-range: 0.02-0.5 Å⁻¹). All SAXS data reduction and model fitting were processed using the Nika/Irena package. The q-space of the SAXS data was corrected using Silver behenate (AgBe).

Gel permeation chromatography (Tosoh EcoSEC HLC-8420 GPC) was used to analyze the molecular weight of the pristine PET and oxidized samples. The column temperature was maintained at 40° C. and the flow rate was 0.3 mL/min. 1-1-1-3-3-3-Hexafluoro-2-propanol (HFIP), containing 0.01N of sodium trifluoroacetate, was delivered as the elution solvent. Polymethylmethacrylate (PMMA) standards were used to correct the molecular weight.

### <Experimental Example 1> Molecular Characterization of Hard Carbon According to Thermal Oxidation Temperature

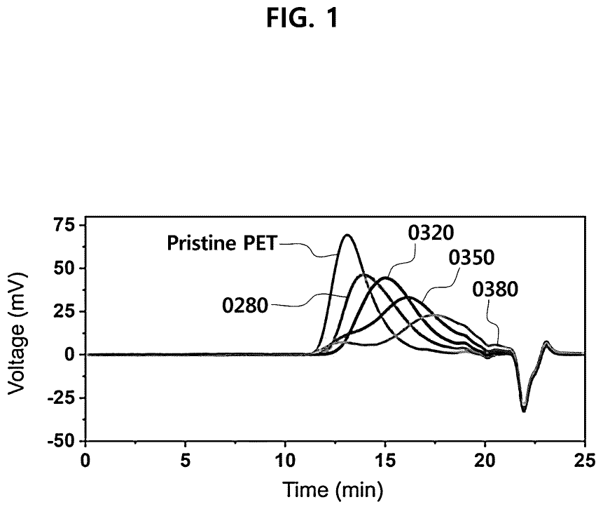

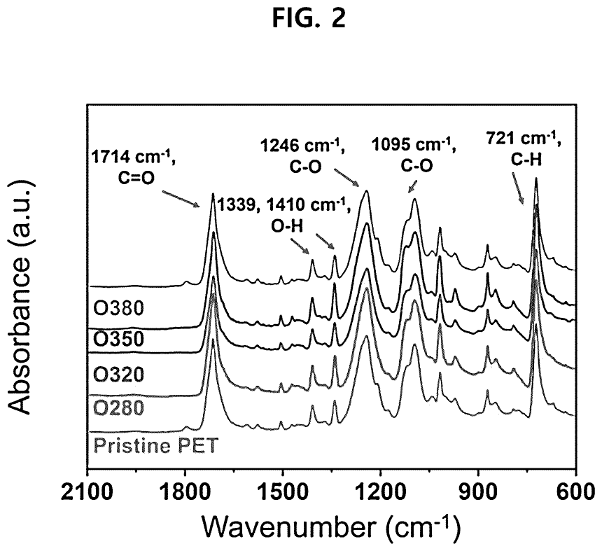

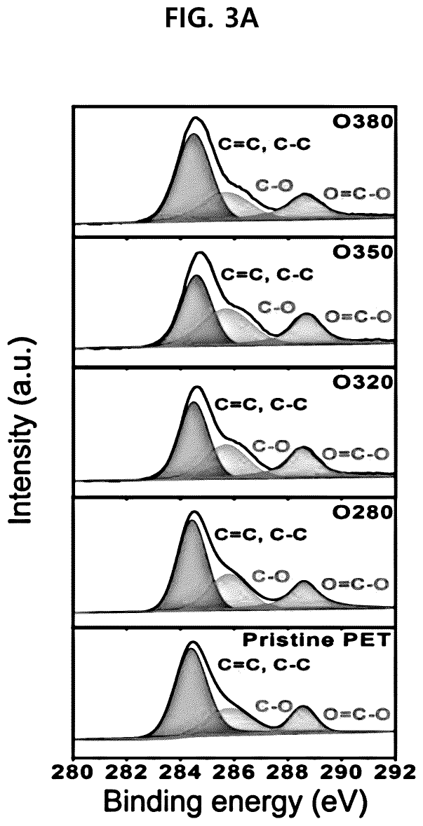

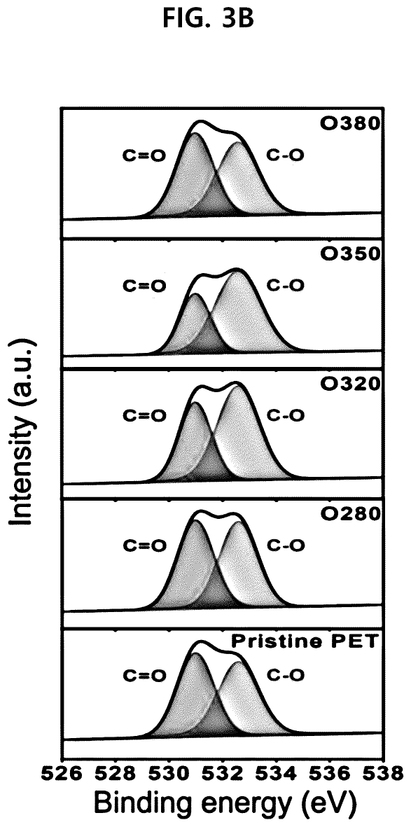

Molecular properties were confirmed for the hard carbon anode prepared in preparation example 1. The results are shown in Table 1 and FIGS. 1 to 3 (Mn: number average molecular weight, Mw: weight average molecular weight). FIG. 1 is a graph showing a gel permeation chromatography (GPC) curve of hard carbon according to an embodiment of the present disclosure. FIG. 2 is a graph showing a Fourier transform infrared (FT-IR) spectroscopy spectrum curve of hard carbon according to an embodiment of the present disclosure. FIG. 3 are graph showing an X-ray photoelectron spectroscopy (XPS) curve of hard carbon according to an embodiment of the present disclosure (FIG. 3A: C 1s, FIG. 3B: O s).

TABLE 1

| Classification | Mn | Mw | PDI | Oxidation yield (%) |
|---|---|---|---|---|
| Primitive PET | 48000 | 142000 | 2.96 | |
| O280 | 39640 | 107820 | 2.72 | 99.5 |
| O320 | 22000 | 50160 | 2.28 | 98.1 |
| O350 | 20800 | 85696 | 4.12 | 96 |
| O380 | 11980 | 83620 | 6.98 | 93 |

From Table 1, it may be confirmed that the number average molecular weight (Mn) of the PET main chain, which is hard carbon precursor, gradually decreased as the thermal oxidation temperature increased. As the molecular weight decreased, the polydispersity index (PDI) also decreased, indicating that the polymer main chain was decomposed by thermal oxidation reaction. From this, it may be seen that the polymer main chain was decomposed by thermal oxidation reaction.

From FIG. 1, the gel permeation chromatography (GPC) data for O280 and O320 show that the main peak position gradually shifts as the thermal oxidation temperature increases. In the gel permeation chromatography (GPC) data, the main peaks of O350 and O380 were divided into two, of which the smaller peak corresponds to the pristine PET molecule and the higher peak is derived from the newly formed small molecule.

From FIG. 2, the Fourier transform infrared (FT-IR) spectroscopy spectra of all the thermally oxidized PET samples showed similar profiles, indicating that the primary binding properties of the PET were not greatly changed by the thermal oxidation process.

From FIG. 3, the XPS C Is spectra showed a change in the relative intensity of C—O to other bonds, where the relative C—O bond intensity increased slightly when the oxidation temperature was 350° C., and thus the oxygen content also increased slightly. A similar trend was observed in the XPS O Is spectra. The increase in oxygen content is due to the increase in oxygen terminal groups along with main chain cleavage. However, O380 shows a large decrease in oxygen content, especially at the C—O bond, suggesting that the decarboxylation reaction proceeded substantially as a secondary thermal process. This reaction produces a wide range of cyclic oligomers and aromatic compounds that are not detectable in the FT-IR spectra and XPS data due to the similar molecular structure as PET.

### <Experimental Example 2> Analysis of Dissolution Characteristics of Hard Carbon According to Thermal Oxidation Temperature

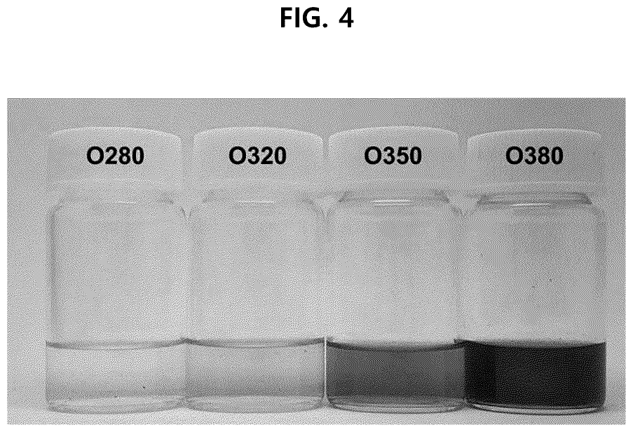

Dissolution characteristics were confirmed for the hard carbon anode prepared in preparation example 1. The results are shown in FIG. 4. FIG. 4 is an optical image of hard carbon according to an embodiment of the present disclosure. From FIG. 4, it may be confirmed that the optical image of the thermally oxidized PET solution (1 wt %) dissolved in 1,1,1,3,3,3-hexafluoro-2-propanol (HFIP) shows a gradual color change from transparent to dark brown close to black depending on the thermal oxidation temperature. The thermally oxidized PET solute was completely dissolved in the solvent, indicating that some macromolecules formed by the intermolecular crosslinking reaction were produced, which is also supported by the GPC results.

### <Experimental Example 3> Analysis of Reaction Behavior of Hard Carbon According to Thermal Oxidation Temperature

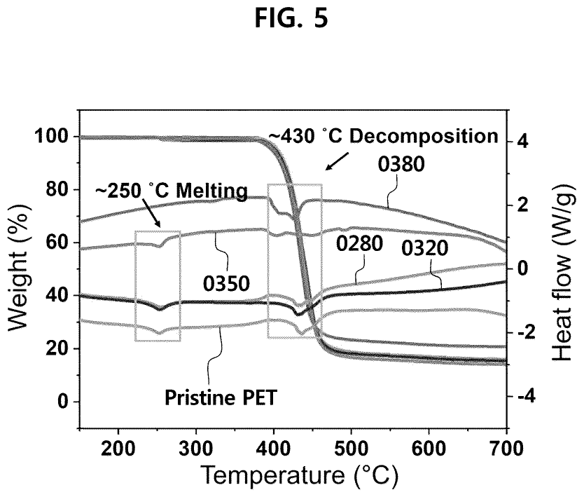

The reaction behavior was confirmed for the hard carbon anode prepared in preparation example 1. More specifically, thermogravimetric analysis (TGA) was performed on PET samples thermally oxidized at different temperatures at a heating rate of 5° C./min under a nitrogen flow of 200 ml/min, and differential scanning calorimetry (DSC) analysis was performed. The results are shown in FIG. 5. FIG. 5 is a graph showing a thermogravimetric analysis (TGA) curve and a differential scanning calorimetry (DSC) curve of hard carbon according to an embodiment of the present disclosure.

From the thermogravimetric analysis (TGA) results of FIG. 5, it may be confirmed that almost the same thermogravimetric analyses (TGA) curves are shown. The pyrolysis occurs at ˜380° C., with about 17% of the initial weight being retained for O280, O320 and O350, while a higher yield of about 20% is retained for O380. This is because some molecules of O380 have already decomposed during the oxidation process since the thermal oxidation temperature is the starting point of the thermal decomposition. This may also be seen from the oxidation yields in Table 1.

From the differential scanning calorimetry (DSC) results of FIG. 5, it may be confirmed that the DSC curves of bare PET, O280, O320 and O350 show melting peaks at 250° C., while the DSC curve of O380 does not show melting peaks. This indicates that O380 lost the crystallographic properties of PET in the thermal oxidation process. The large number of small molecules produced in the thermal oxidation process mitigates intra-molecular and inter-molecular interactions of the PET molecules and prevents crystallization. In addition, the second highest endothermic peak was observed at 400° C. or higher for all samples, and the peaks of O350 and O380 were divided into two parts. This is because smaller molecules thermally decompose at lower temperatures. Shortly before the second endothermic peak appeared, a broad exothermic slope was observed in the DSC curves of the bare PET and O280, despite the onset of a sharp weight loss at this temperature. In the DSC curve of O320, the exothermic slope disappeared as the endothermic reaction became dominant, and strong endothermic peaks were observed in O350 and O380. In the case of O350 and O380, the pyrolysis of CO or CO₂ occurs mainly due to the low intermolecular interactions, wherein the remaining aromatic rings may be fused into a polyaromatic structure. In contrast, bare PET and O280 were primarily cross-linked prior to pyrolysis. This difference in pyrolysis behavior results in very different carbon microstructures in the polymeric hard carbons.

### <Experimental Example 4> Microstructural Analysis 1 of Hard Carbon According to Thermal Oxidation Temperature and Heating Temperature

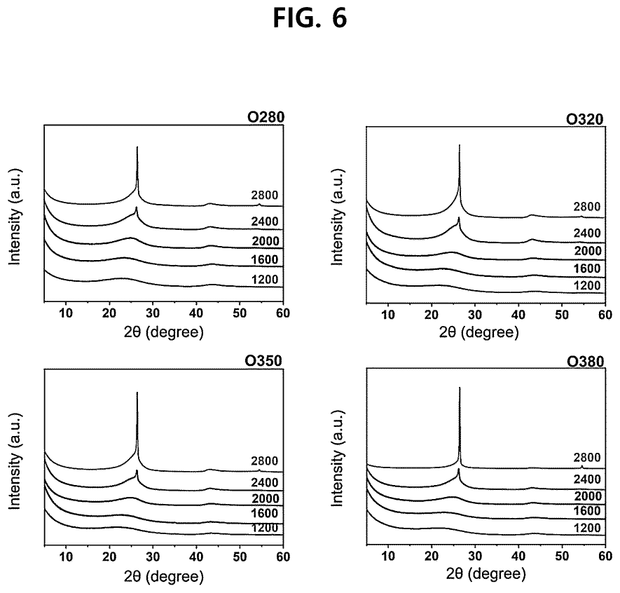

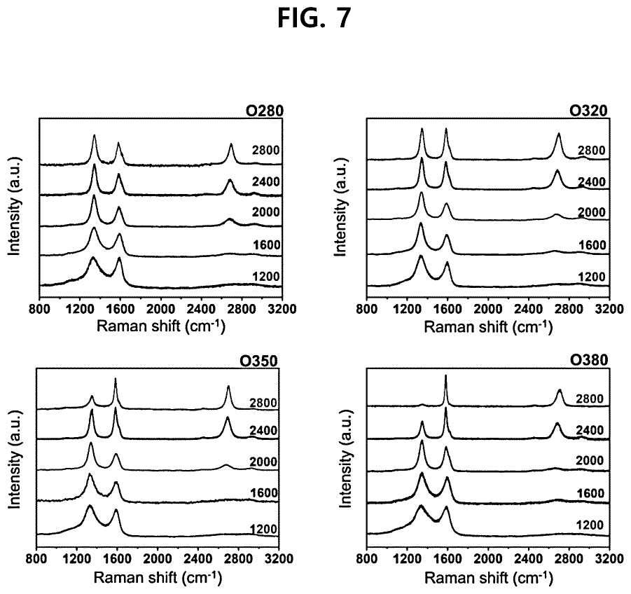

The microstructure was confirmed for the hard carbon anode prepared in preparation example 2. The results are shown in Table 2 and FIGS. 6 and 7. FIG. 6 is a graph showing an X-ray diffraction (XRD) curve of hard carbon according to an embodiment of the present disclosure. FIG. 7 is a graph showing the Raman spectrum curve of hard carbon according to an embodiment of the present disclosure.

TABLE 2

| Classification | d₀₀₂ (Å) | Lₐ (nm) | L_{c} (nm) |
|---|---|---|---|
| O280-1200 | 3.83 | 1.82 | 0.97 |
| O280-1600 | 3.78 | 1.90 | 1.08 |
| O280-2000 | 3.64 | 2.31 | 1.38 |
| O280-2400 | 3.40 | 2.5 | 3.21 |
| O280-2800 | 3.37 | 4.68 | 12.06 |
| O320-1200 | 3.91 | 1.94 | 1.05 |
| O320-1600 | 3.83 | 2.05 | 1.24 |
| O320-2000 | 3.65 | 2.21 | 1.43 |
| O320-2400 | 3.38 | 2.61 | 3.95 |
| O320-2800 | 3.37 | 5.43 | 18.49 |
| O350-1200 | 3.99 | 1.91 | 1.14 |
| O350-1600 | 3.86 | 2.1 | 1.22 |
| O350-2000 | 3.67 | 2.55 | 1.34 |
| O350-2400 | 3.39 | 3.21 | 3.28 |
| O350-2800 | 3.37 | 14.19 | 18.54 |
| O380-1200 | 3.94 | 2.07 | 1.07 |
| O380-1600 | 3.84 | 2.41 | 1.12 |
| O380-2000 | 3.65 | 2.78 | 1.4 |
| O380-2400 | 3.40 | 7.09 | 6.18 |
| O380-2800 | 3.37 | 53.01 | 33.67 |

From FIG. 6, it may be confirmed that in the case of polymeric hard carbons prepared at a relatively low heating temperature of 2000° C. or less, the XRD pattern shows a very broad graphite (002) peak regardless of the oxidation temperature, while a sharp graphite (002) peak occurs in the sample prepared at heating temperature of 2400° C., and the sharp peak increases greatly in the sample prepared at heating temperature of 2800° C. The effect of oxidation temperature was clearly observed in samples treated at 2400° C. and 2800° C., where the graphite (002) peak became more strengthened and narrowed with increasing oxidation temperature. The gradual improvement in graphite (002) peak intensity and sharpness indicates that the graphite layer is more regular and developed. In particular, the presence of sharp graphite (002) peaks for samples treated at 2400° C. and 2800° C. indicates that a well-aligned graphite structure has developed in the bulk microstructure.

In addition, from Table 2, it may be confirmed that the growth of the graphite structure has a denser lattice spacing of 3.4 Å or less by reducing the d-spacing of the graphite lattice from 3.99 Å to 3.37 Å with densification of the graphite layer. According to the Scherrer relation Lc=Kλ/βcosθ, the thickness (Lc) of the graphite layer was found to be 0.97 to 33.67 nm. A clear growth of the Lc values was observed in samples prepared at higher heating temperatures of 2400° C. or higher, where the Lc values became higher as the thermal oxidation temperature increased. It may be confirmed that the La value gradually increased as the heating temperature increased, wherein a higher thermal oxidation temperature in the sample with the same heating temperature resulted in a higher La value. In particular, the S380-2800 sample exhibited a significantly higher La value of ˜53 nm.

From FIG. 7, the Raman spectra of all the polymeric hard carbon samples may confirm the characteristic D and G bands of the sp² structure carbon material. The D band arises from various coupled vibrational modes from various carbon defect structures, while the G band is induced by the primary Raman active mode of highly ordered graphite domains. In samples heated at a temperature of 1200° C., the D and G bands are fused together, indicating that most of the aligned graphene building blocks are mixed with defective carbon structures without clear phase separation. The fusion of the D and G bands was significantly mitigated in the Raman spectra of samples heated at a temperature of 1600° C., showing clearly separated bands for samples heated at temperatures of 2000° C. or higher. The D to G band intensity ratio (ID/IG) represents the size (La) of the aligned graphene domains.

### <Experimental Example 5> Microstructural Analysis 2 of Hard Carbon According to Thermal Oxidation Temperature and Heating Temperature

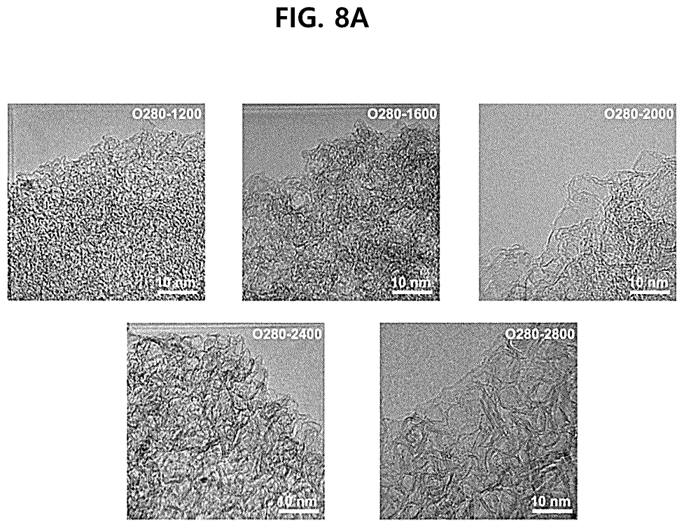

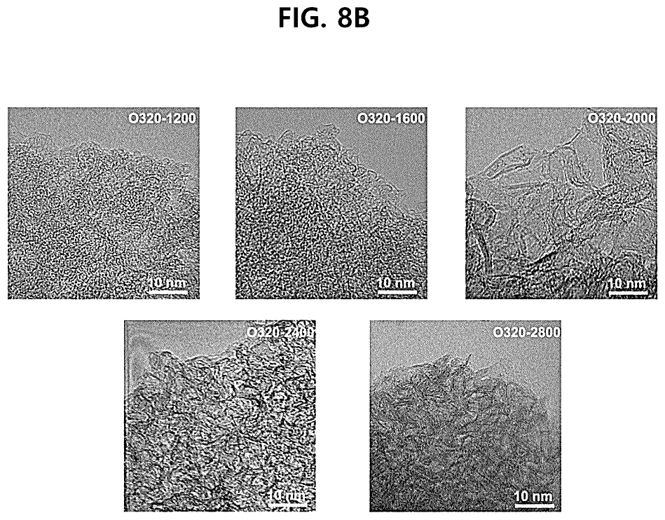

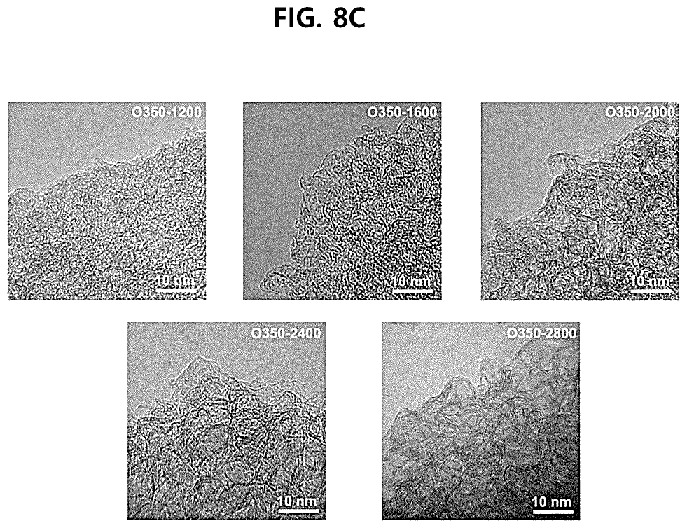

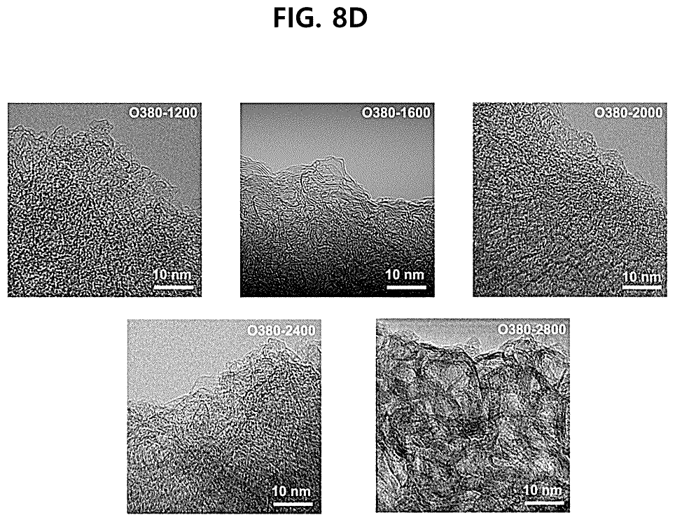

The microstructure was confirmed for the hard carbon anode prepared in preparation example 2. The results are shown in FIGS. 8A to 8D. FIGS. 8A to 8D transmission electron microscope image of hard carbon according to an embodiment of the present disclosure (FIG. 8A: O280, FIG. 8B: O320, FIG. 8C: O350, FIG. 8D: O380). From FIGS. 8A to 8D, high-resolution transmission electron microscopy (HR-TEM) images of samples heated at temperatures of 1600, 2000, 2400 and 2800° C. show that as the heating temperature increases, microstructural transitions occur, and the polyhexagonal carbon domains of the sp² structure become more developed and gradually larger.

### <Experimental Example 6> Microstructural Analysis 3 of Hard Carbon According to Thermal Oxidation Temperature and Heating Temperature

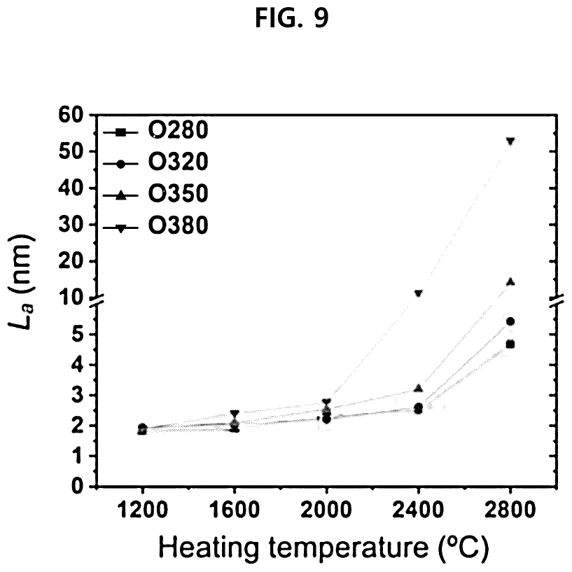

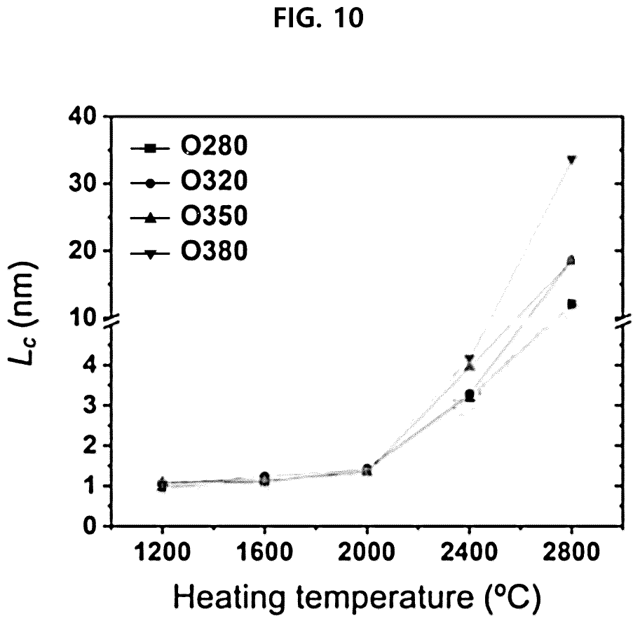

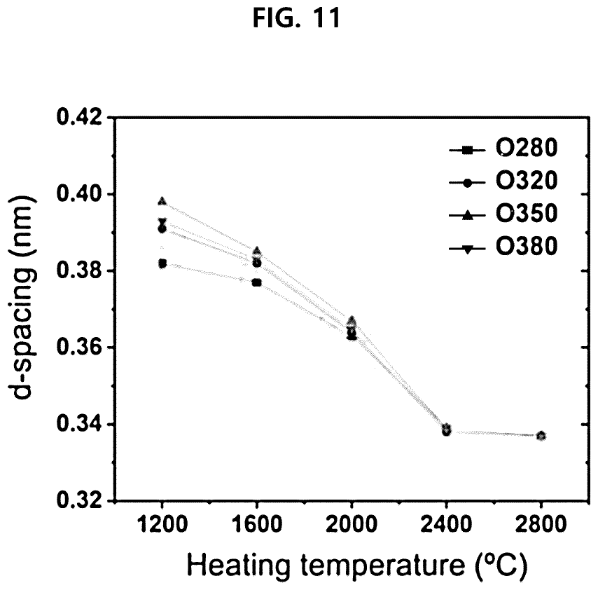

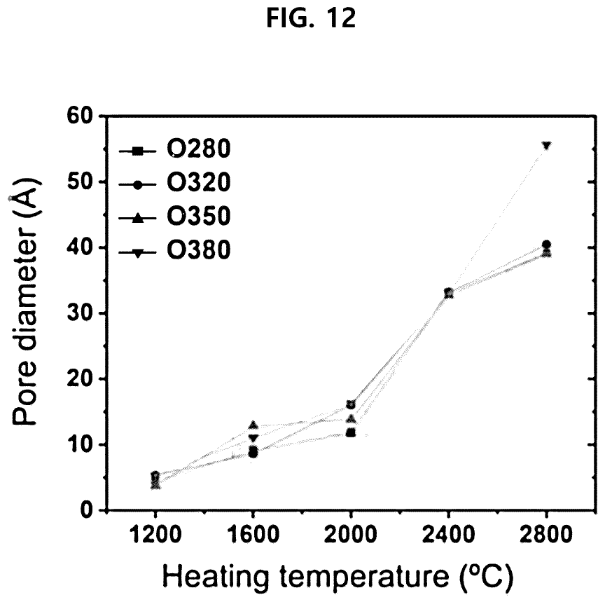

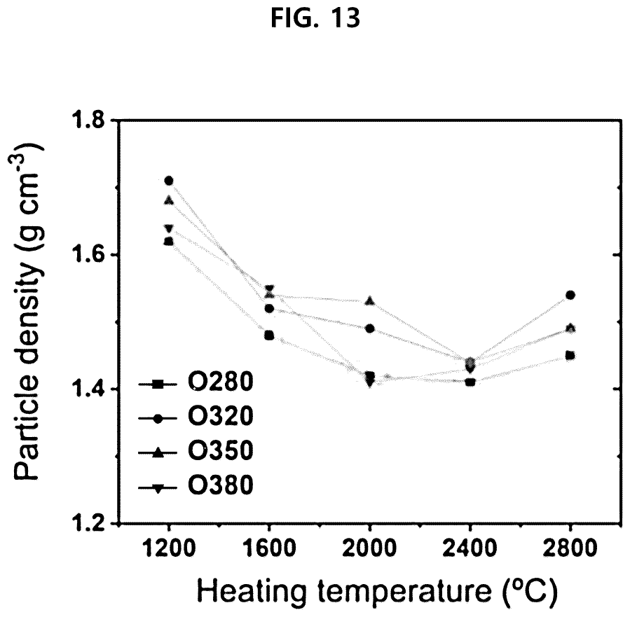

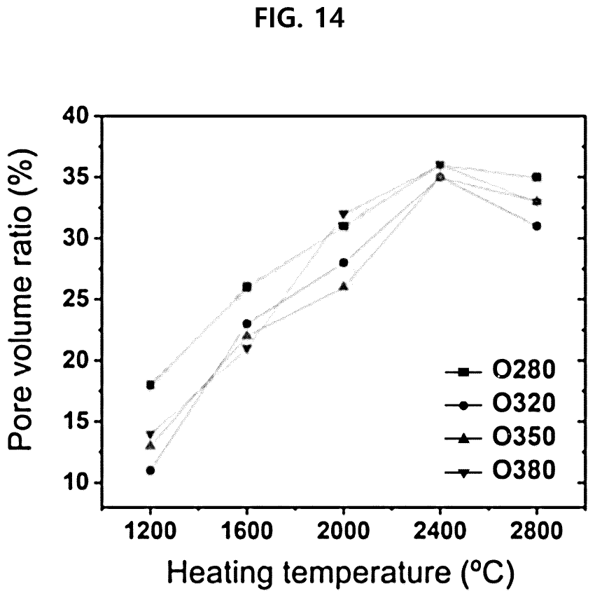

The microstructure was confirmed for the hard carbon anode prepared in preparation example 2. The results are shown in FIGS. 9 to 14. FIG. 9 is a graph showing the crystal size (La) curve along the a-axis of hard carbon according to an embodiment of the present disclosure. FIG. 10 is a graph showing the crystal size (Lc) curve along the c-axis of hard carbon according to an embodiment of the present disclosure. FIG. 11 is a graph showing a d-spacing curve of hard carbon according to an embodiment of the present disclosure. FIG. 12 is a graph showing an average pore diameter curve of hard carbon according to an embodiment of the present disclosure. FIG. 13 is a graph showing a particle density curve of hard carbon according to an embodiment of the present disclosure. FIG. 14 is a graph showing a pore volume ratio curve of hard carbon according to an embodiment of the present disclosure.

From FIG. 9 and FIG. 10, it may be confirmed that the La and Lc values of the hard carbon according to an embodiment of the present disclosure gradually increased from 1.82 to 53.01 nm and from 0.97 to 33.67 nm, respectively, as the heating temperature increased from 1200° C. to 2800° C. The thermal oxidation temperature also affected the La and Lc values. It may be confirmed that the La and Lc values of the hard carbon according to an embodiment of the present disclosure gradually increased from 1.82-4.68 and 0.97-12.06 nm to 2.07-53.01 and 1.07-33.67 nm, respectively, while increasing the thermal oxidation temperature from 280° C. to 380° C.

From FIGS. 11 and 12, it may be confirmed that the d-spacing value of the hard carbon according to an embodiment of the present disclosure gradually decreased from 3.99 Å to 3.37 Å as the heating temperature increased from 1200° C. to 2800° C. These results indicate that the graphite structure continuously develops into a denser structure as the heating temperature increases, and that higher thermal oxidation temperatures lead to greater densification. With the development of aligned graphitic regions, the average pore diameter of hard carbon also gradually increased from 3.75 Å to 55.63 Å depending on the heating temperature.

From FIG. 13 and FIG. 14, it may be confirmed that the particle density of the hard carbon according to an embodiment of the present disclosure exhibits a parabolic shape, as opposed to the La, Lc, d-spacing and pore diameter of the hard carbon of an embodiment of the disclosure varying continuously. The decrease in particle density indicates that more closed pores were formed in the internal structure of the hard carbon as the heating temperature increased. From the closed pore volume ratio values calculated from the particle density, it may be confirmed that the relatively hot heated hard carbon generally exhibits a high closed pore volume ratio of 25.0% or more.

### <Reference Example 2> Preparation of Half Cells and Sodiation and Lithiation of Half Cells

A sodium half cell was constructed using the hard carbon prepared in preparation example 2 or Preparation Example 3 as the working electrode, sodium foil as the counter/reference electrode, a glass microfilter separator, and a sodium-based electrolyte (1M NaPF₆ from EC/DEC). The sodium half cell was pre-circulated in constant-current mode at current density of 25 mA/g over a voltage window range of [0-2.0 V vs Na⁺/Na].

A sample of the half cells was sodiated at 0.001 V and then the fully sodiated 0280-2400 or A30 working electrode was extracted from the sodium half cell. Lithium foil was used as the counter/reference electrode under argon (Ar) atmosphere and reassembled with a new separator (glass microfiber filter) and lithium-based electrolyte (1M LiPF₆ from EC/DEC). The fully sodiated electrodes were sequentially lithiated in the lithium half cell, over voltage window range of 0.34-0.01 V, and delithiated over a range of [up to 2.0 V vs. Li⁺/Li].

### <Experimental Example 7> Structural Index Analysis 1 of Hard Carbon

The structural index of the hard carbon was analyzed for the half cell of reference example 2 using the hard carbon prepared in preparation example 2. More specifically, the SPC factor of the polymeric hard carbons was derived according to the following equation 1 at operating voltages of 25° C. and 60° C.

$$SPC factor = ( 1 - Pore volume ratio \times \frac{{I}_{2 D}}{{I}_{G}} ) \qquad [ Equation 1 ]$$

In the above equation 1, the pore volume ratio is the volume ratio of closed pores, and the peak intensity ratio (I_{2D}/I_{G}) of the 2D band to the G band is the peak intensity ratio of the 2D band (near 2690 cm⁻¹) to the G band (near 1580 cm⁻¹) as measured by Raman spectroscopy.

On the other hand, the coefficient of capacity utilization (CCU) of the polymeric hard carbons was derived according to the following equation 2.

$$\frac{SPC}{T - SPC} ( CCU ) = a ( 1 - Pore volume ratio \times \frac{{I}_{2 D}}{{I}_{G}} ) + b \qquad [ Equation 2 ]$$

In the above equation 2, a and b may be affected by the operating temperature, precursor material, manufacturing process, and other factors. a and b are external factors that are not inherent characteristics of the carbon material, and may include various factors such as temperature conditions during electrochemical analysis, types and processes of precursors used when manufacturing the carbon material.

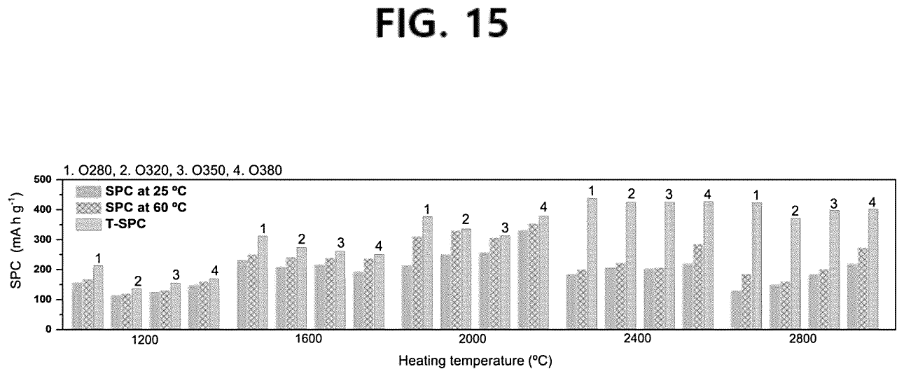

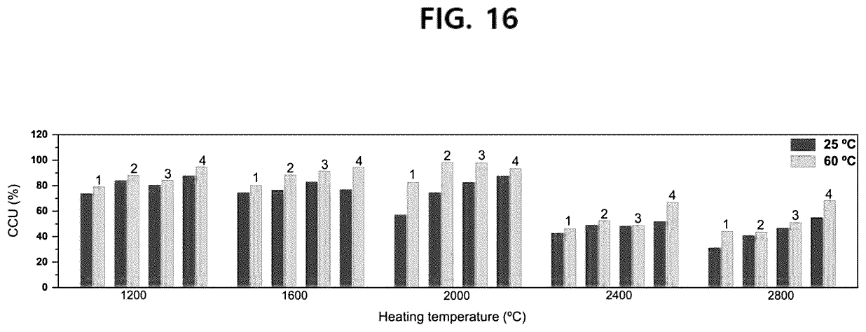

The results are shown in Table 3 and FIGS. 15 and 16. FIG. 15 is a graph showing an SPC capacity curve of hard carbon according to an embodiment of the present disclosure. FIG. 16 is a graph showing a coefficient of capacity utilization (CCU) curve of hard carbon according to an embodiment of the present disclosure.

TABLE 3

| | | Pore Volume | SPC | CCU (%) | CCU (%) |
|---|---|---|---|---|---|
| Classification | I_{2D}/I_{G} | Ratio (%) | Factor | at 25° C. | at 60° C. |
| O280-1200 | 0.15 | 18 | 0.97 | 73.26 | 78.81 |
| O280-1600 | 0.15 | 26 | 0.96 | 74.10 | 80.18 |
| O280-2000 | 0.43 | 31 | 0.87 | 56.53 | 82.28 |
| O280-2400 | 0.76 | 36 | 0.73 | 42.01 | 45.69 |
| O280-2800 | 0.9 | 35 | 0.69 | 30.43 | 43.72 |
| O320-1200 | 0.13 | 11 | 0.99 | 83.61 | 87.74 |
| O320-1600 | 0.2 | 23 | 0.95 | 75.91 | 88.24 |
| O320-2000 | 0.36 | 29 | 0.9 | 74.13 | 98.16 |
| O320-2400 | 0.71 | 35 | 0.75 | 48.36 | 52.23 |
| O320-2800 | 0.85 | 31 | 0.74 | 40.32 | 43.10 |
| O350-1200 | 0.11 | 13 | 0.99 | 79.99 | 84.05 |
| O350-1600 | 0.18 | 22 | 0.96 | 82.48 | 91.26 |
| O350-2000 | 0.35 | 29 | 0.9 | 82.15 | 97.77 |
| O350-2400 | 0.7 | 35 | 0.76 | 47.62 | 48.47 |
| O350-2800 | 0.76 | 33 | 0.75 | 46.16 | 50.48 |
| O380-1200 | 0.1 | 14 | 0.99 | 87.25 | 94.53 |
| O380-1600 | 0.19 | 21 | 0.96 | 76.42 | 94.17 |
| O380-2000 | 0.18 | 32 | 0.94 | 87.20 | 94.24 |
| O380-2400 | 0.54 | 36 | 0.81 | 51.23 | 66.52 |
| O380-2800 | 0.55 | 33 | 0.82 | 54.23 | 67.96 |

From FIG. 15, it may be confirmed that the gap between the SPC capacity and the theoretical SPC capacity (T-SPC) is relatively small in hard carbon sample heated to relatively low temperature of 2000° C. or lower. In addition, from FIG. 16, it may be confirmed that the operating temperatures of 25° C. and 60° C. show high CCU values of 73.26%-87.25% and 78.81%-98.16%, respectively. These results indicate that most of the closed pore volume is available in hard carbon samples heated to relatively low temperatures of 2000° C. or lower. In contrast, hard carbon samples heated at high temperatures of 2400° C. or higher show low CCU values of 30.43%-54.23% and 43.10%-67.96% at 25° C. and 60° C., respectively. Thus, despite the high closed pore volume ratio, the SPC capacity was lower than that of the low temperature heated sample.

On the other hand, in order to derive the cause of this discrepancy, the correlation between each of La, Lc, d-spacing, particle density, pore volume ratio and pore diameter, and SPC capacity was investigated, but none of the above parameters was directly related to the trend of SPC capacity change.

### <Experimental Example 8> Structural Index Analysis 2 of Hard Carbon

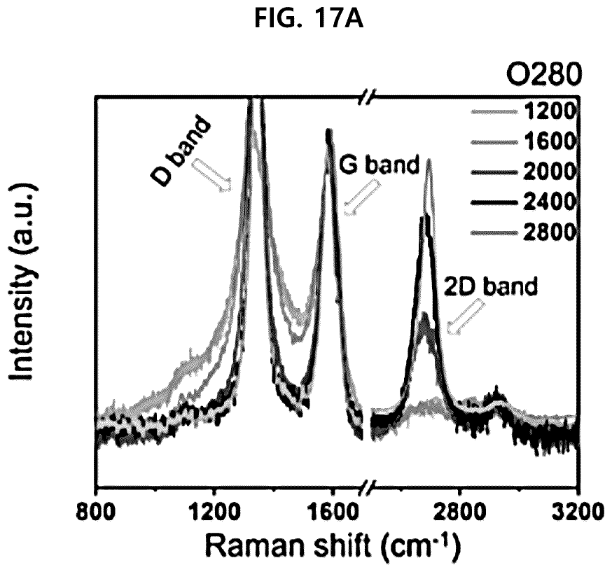

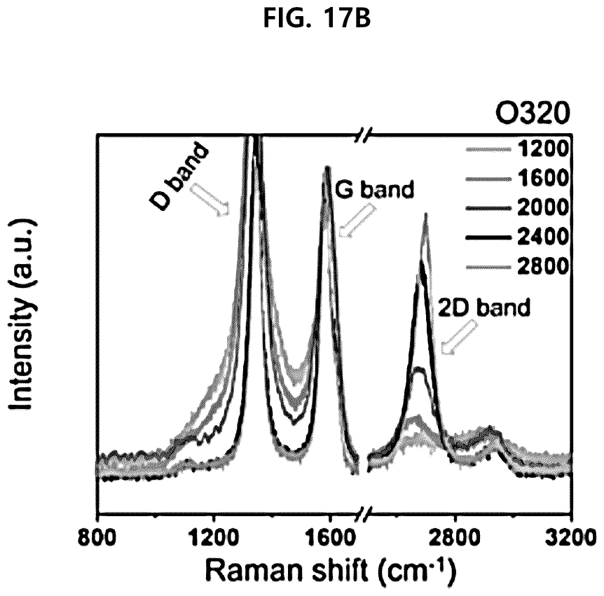

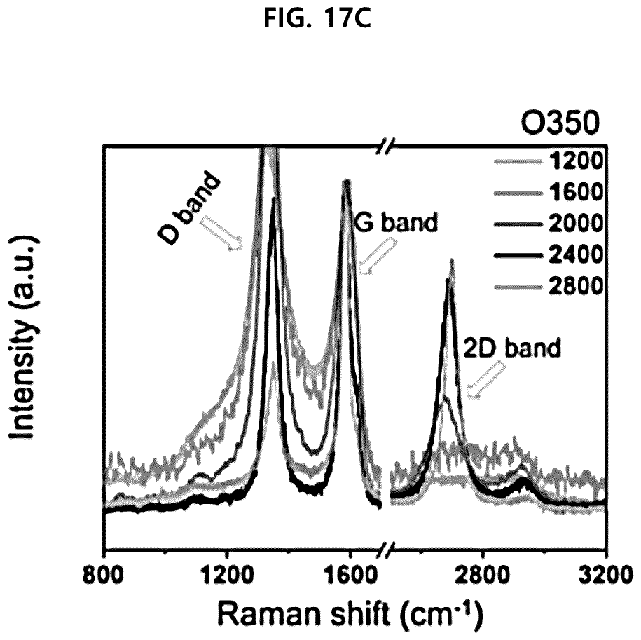

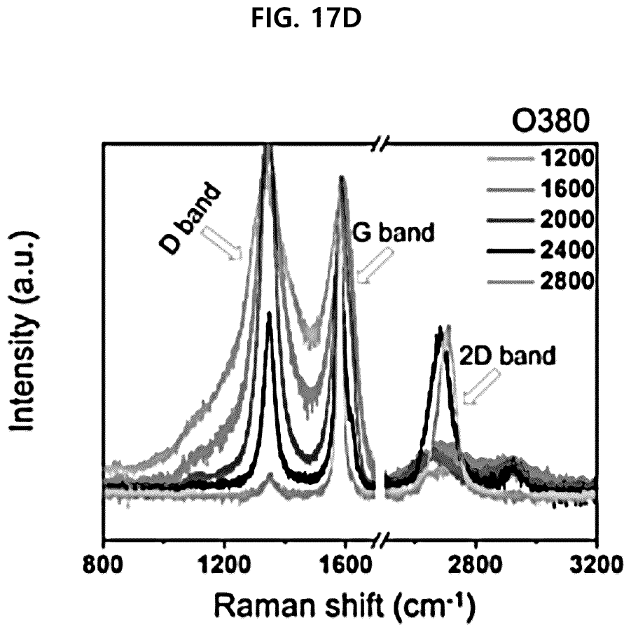

The structural index of the hard carbon was analyzed for the half cell of reference example 2 using the hard carbon prepared in preparation example 2. The results are shown in FIGS. 17A to 17D. FIGS. 17A to 17D are graph showing the Raman spectrum curve of hard carbon according to an embodiment of the present disclosure (FIG. 17A: O280, FIG. 17B: O320, FIG. 17C: O350, FIG. 17D: O380).

From FIGS. 17A to 17D, it may be confirmed that the G band (near 1580 cm⁻¹) is induced by the primary Raman active mode for highly ordered polyhexagonal region, while the 2D band (near 2690 cm⁻¹) arises from secondary Raman scattering by in-plane transverse phonon near the boundary of the Brillouin zone. The 2D band is due to the local arrangement of the graphitic structure and the number of graphitic layers. Thus, the peak intensity ratio (I_{2D}/I_{G}) value of the 2D band to the G band may indicate the degree of densification of the graphite structure that may interfere with sodium ion migration inside the hard carbon.

### <Experimental Example 9> Structural Index Analysis 3 of Hard Carbon

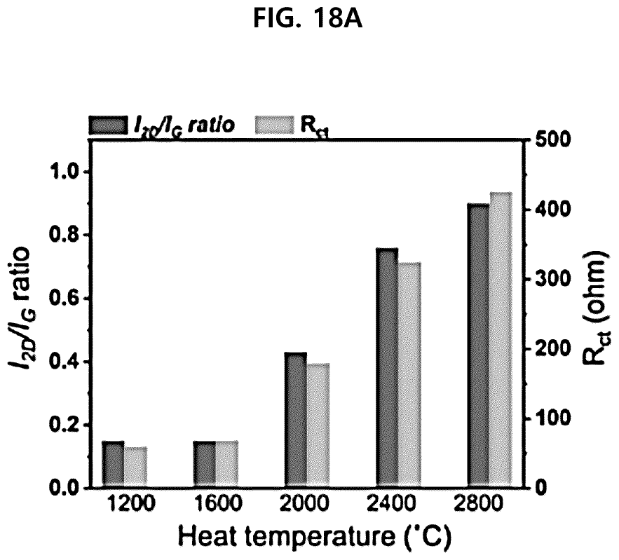

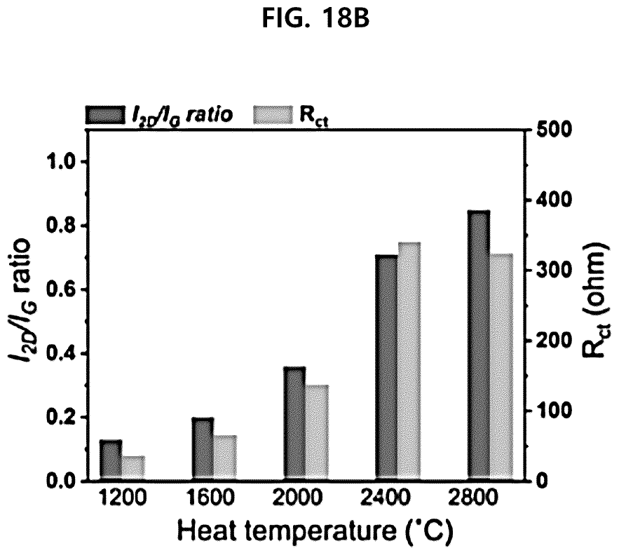

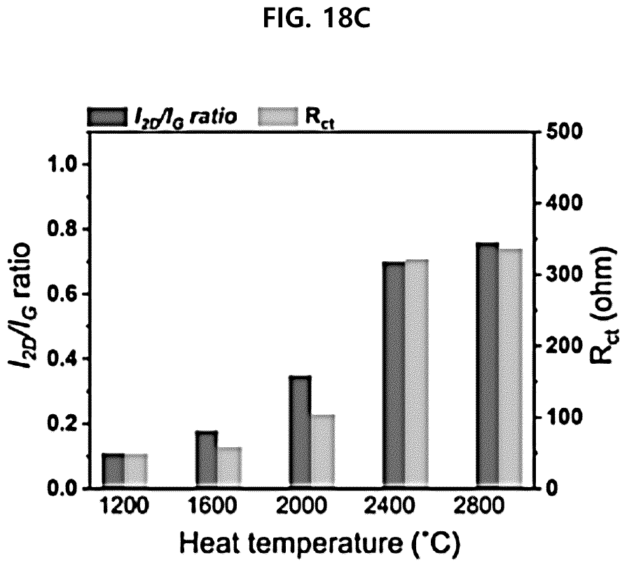

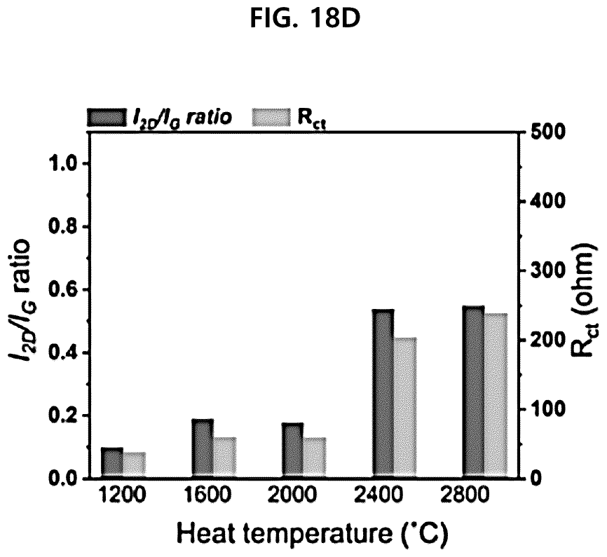

The structural index of the hard carbon was analyzed for the half cell of reference example 2 using the hard carbon prepared in preparation example 2. The results are shown in FIGS. 18A to 18D. FIGS. 18A to 18D are graph showing a peak intensity ratio (I_{2D})/I_{G}) value of a 2D band to a G band and a charge-transfer resistance value of hard carbon according to an embodiment of the present disclosure (FIG. 18A: O280, FIG. 18B: O320, FIG. 18C: O350, FIG. 18D: O380). From FIG. 18, it may be confirmed that the electrochemical impedance spectroscopy (EIS) profile has a close relationship between the peak intensity ratio (I_{2D})/I_{G}) value of the 2D band to the G band and the charge-transfer resistance (Rct) value.

### <Experimental Example 10> Structural Index Analysis 4 of Hard Carbon

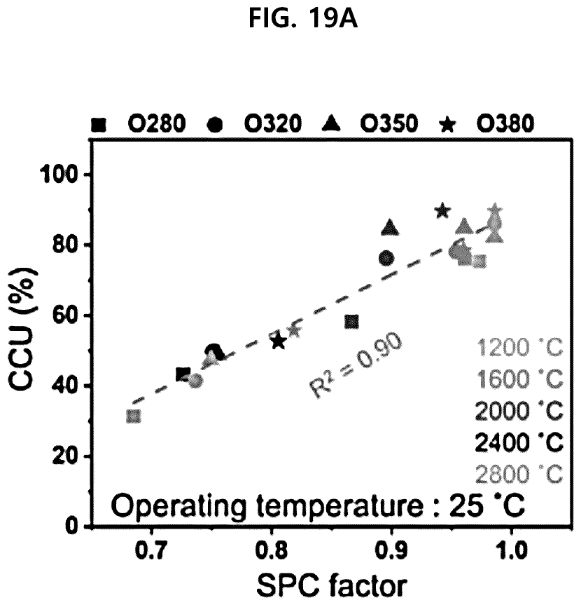

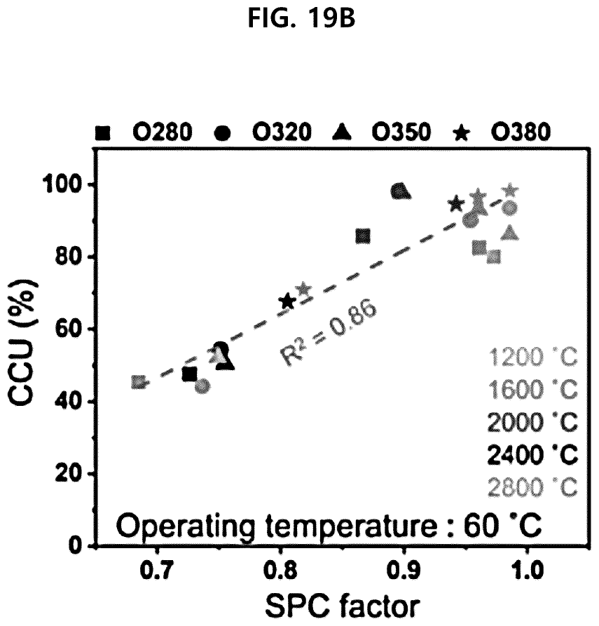

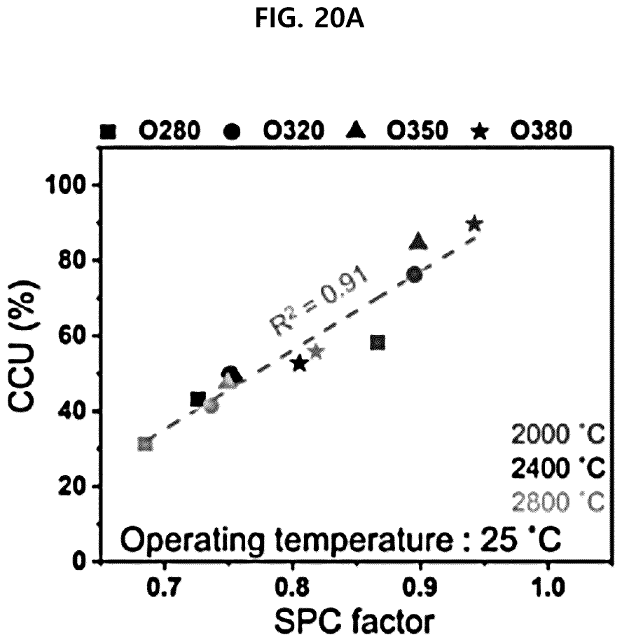

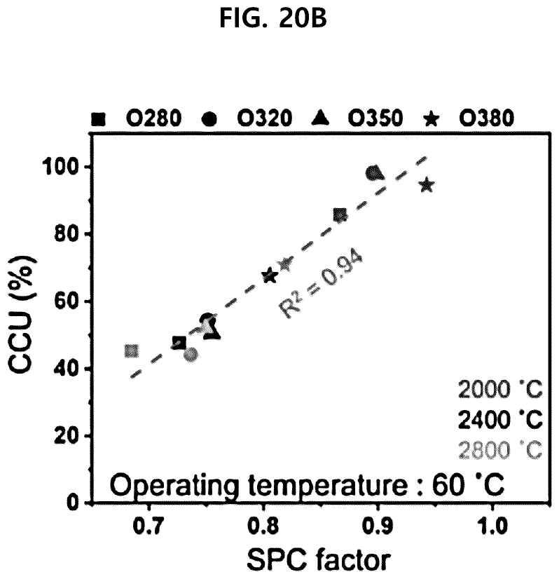

The structural index of the hard carbon was analyzed for the half cell of reference example 2 using the hard carbon prepared in preparation example 2. The results are shown in FIGS. 19 and 20. FIGS. 19A and 19B are graph showing the coefficient of capacity utilization (CCU) and a SPC factor curve of hard carbon according to an embodiment of the present disclosure (FIG. 19A: operating temperature of 25° C., FIG. 19B: operating temperature of 60° C.). FIGS. 20A and 20B are graph showing the coefficient of capacity utilization (CCU) and the SPC factor curve of hard carbon according to an embodiment of the present disclosure (FIG. 20A: operating temperature of 25° C., FIG. 20B: operating temperature of 60° C.).

From FIGS. 19A and 19B, it may be confirmed that for the half cell test at operating temperatures of 25° C. and 60° C., respectively, all samples show high coefficient of determination (R²) values of 0.90 and 0.86. From FIGS. 20A and 20B, it may be confirmed that the coefficient of determination (R²) values increased to 0.91 and 0.94 at operating temperatures of 25° C. and 60° C., respectively, in samples heated at higher temperatures.

### <Experimental Example 11> Structural Index Analysis 1 of Chemically Activated Hard Carbon

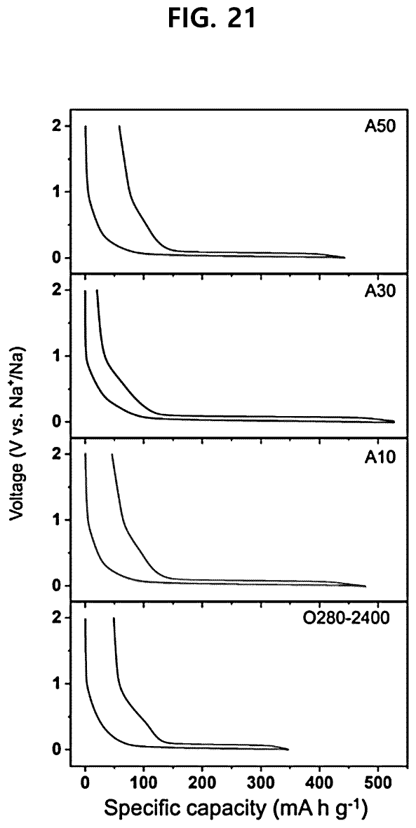

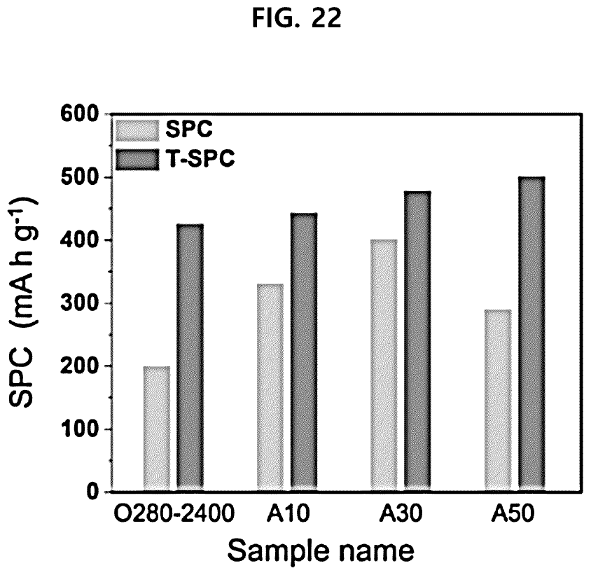

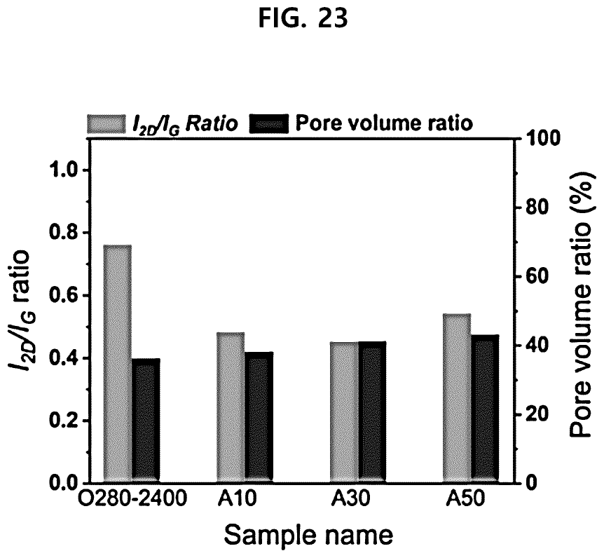

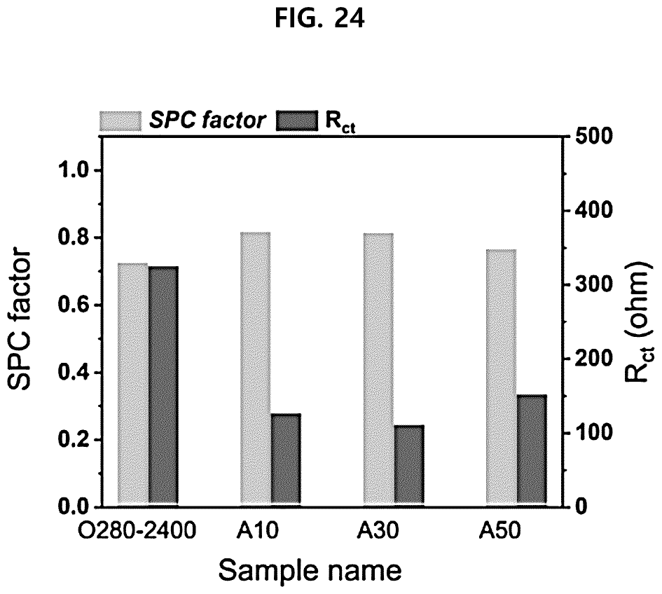

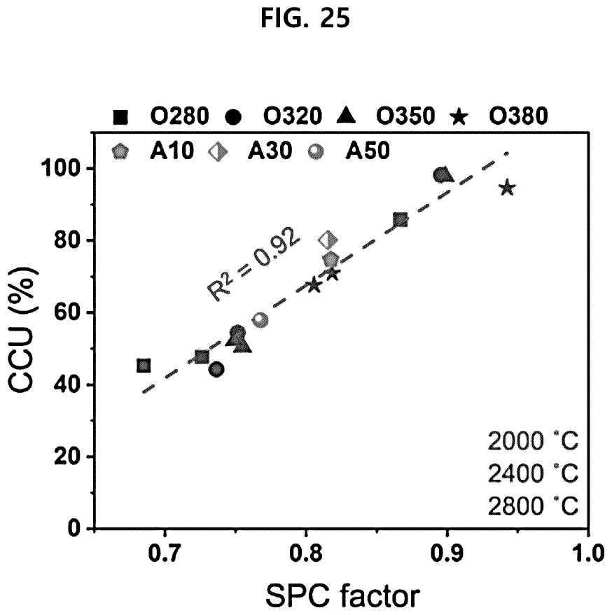

The structural index of the hard carbon was analyzed for the half cell of reference example 2 using the hard carbon prepared in preparation example 3. The results are shown in FIGS. 21 to 24. FIG. 21 is a graph showing a constant-current discharge/charge profile curve of hard carbon according to an embodiment of the present disclosure. FIG. 22 is a graph showing the SPC capacity of hard carbon according to an embodiment of the present disclosure. FIG. 23 is a graph showing the peak intensity ratio (I_{2D})/I_{G}) value of the 2D band to the G band and the pore volume ratio of hard carbon according to an embodiment of the present disclosure. FIG. 24 is a graph showing the SPC factor and the charge-transfer resistance value of hard carbon according to an embodiment of the present disclosure. FIG. 25 is a graph showing the coefficient of capacity utilization (CCU) and the SPC factor curve of hard carbon according to an embodiment of the present disclosure.

From FIG. 21, it may be confirmed that the constant-current discharge/charge profiles of the O280-2400, A10, A30 and A50 samples allow the sodium plateau capacity (SPC) of the hard carbon to be adjusted through controlled chemical activation process. From FIG. 22, it may be confirmed that the reversible sodium plateau capacity (SPC) of O280-2400 (200 mA h g-1) increased to about 330, 400 and 290 mA h g⁻¹ at A10, A30 and A50, respectively, with the increase in sodium plateau capacity being attributed to the increase in SPC factor. From FIG. 23, it may be confirmed that the peak intensity ratio (I_{2D})/I_{G}) value (0.73) of the 2D band to the G band of O280-2400 gradually decreased to 0.48, 0.45, 0.54 in A10, A30, A50, respectively, while the pore volume ratio (36%) of 0280-2400 gradually increased to 38%, 41% and 43% in A10, A30, A50, respectively. From FIG. 24, it may be confirmed that the SPC factor (0.73) of O280-2400 increased to 0.82, 0.82, 0.77 in A10, A30, A50, respectively, and its Rct value (325 (2) decreased greatly to 126, 111 and 152Ω in A10, A30 and A50, respectively. From FIG. 25, it may be confirmed that the SPC factor and the coefficient of capacity utilization (CCU) of the microstructure-adjusted polymeric hard carbons show a linear relationship with high coefficient of determination (R²) value of 0.92.

### <Experimental Example 12> Microstructural Analysis 1 of Chemically Activated Hard Carbon

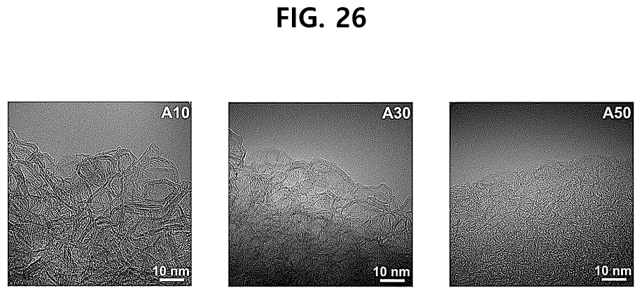

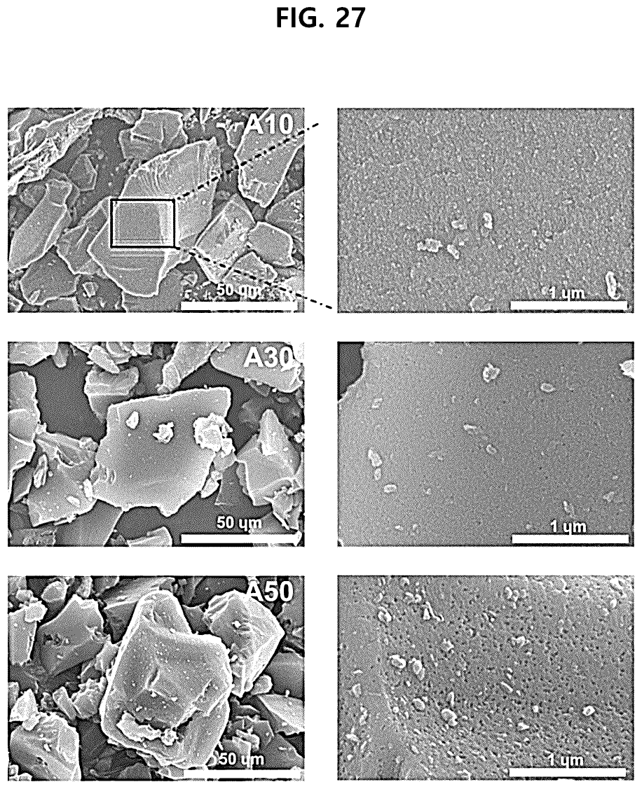

The microstructure was confirmed for the hard carbon anode prepared in preparation example 3. The results are shown in Table 4 and FIGS. 26 and 27. FIG. 26 is the transmission electron microscope image of hard carbon according to an embodiment of the present disclosure. FIG. 27 is a scanning electron microscope image of hard carbon according to an embodiment of the present disclosure.

TABLE 4

| Classification | d₀₀₂ (Å) | Lₐ (nm) | L_{c} (nm) | S_{BET} (m²/g) |
|---|---|---|---|---|
| O280-2400 | 3.40 | 2.5 | 3.21 | 1.15 |
| A10 | 3.38 | 5.56 | 4.7 | 2.31 |
| A30 | 3.43 | 4.41 | 3.1 | 6.50 |
| A50 | 3.43 | 3.94 | 2.8 | 16.28 |

From FIG. 26, it may be confirmed that the microstructure of the hard carbons O280-2400 changes through the controlled chemical activation process. From FIG. 27, it may be confirmed that there are several nano-sized pores on the surface of the hard carbon particles.

### <Experimental Example 13> Microstructural Analysis 2 of Chemically Activated Hard Carbon

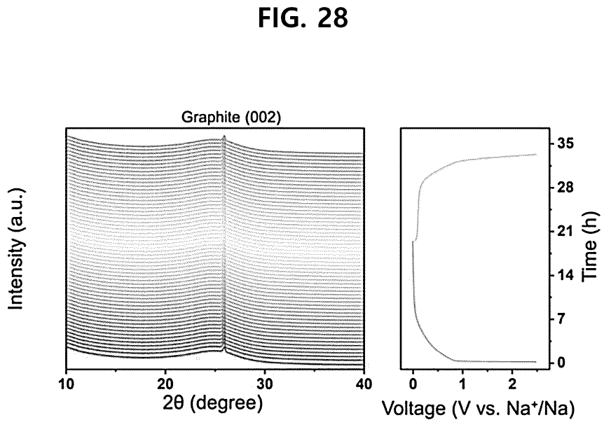

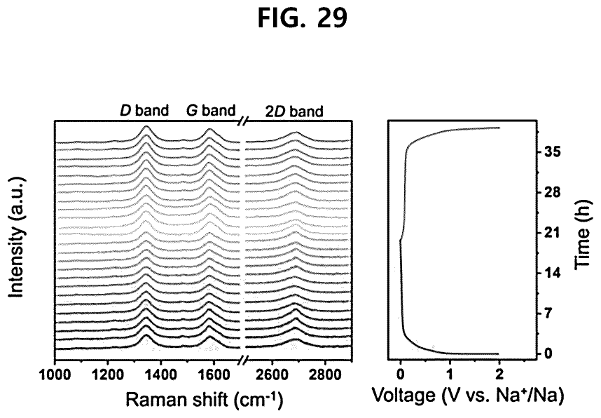

The microstructure was confirmed for A30 in the hard carbon anode prepared in preparation example 3. The results are shown in FIGS. 28 and 29. FIG. 28 is a graph showing the X-ray diffraction (XRD) curve of hard carbon according to an embodiment of the present disclosure. FIG. 29 is a graph showing the Raman spectrum curve of hard carbon according to an embodiment of the present disclosure.

From FIG. 28, it may be confirmed that the in situ XRD pattern showed graphite (002) peak at 25.9°, which did not change in the entire discharge/charge process. From FIG. 29, it may be confirmed that the in situ Raman spectral show no obvious changes in the characteristic D, G and 2D bands during the discharge/charge cycle, indicating that the sodiation process does not involve structural transitions even in localized regions. From the above test results, it may be confirmed that the increased SPC capacity of A30 results from the pore filling mechanism, not the sodium interlayer behavior between the graphite lattices.

### <Experimental Example 14> Microstructural Analysis 3 of Chemically Activated Hard Carbon

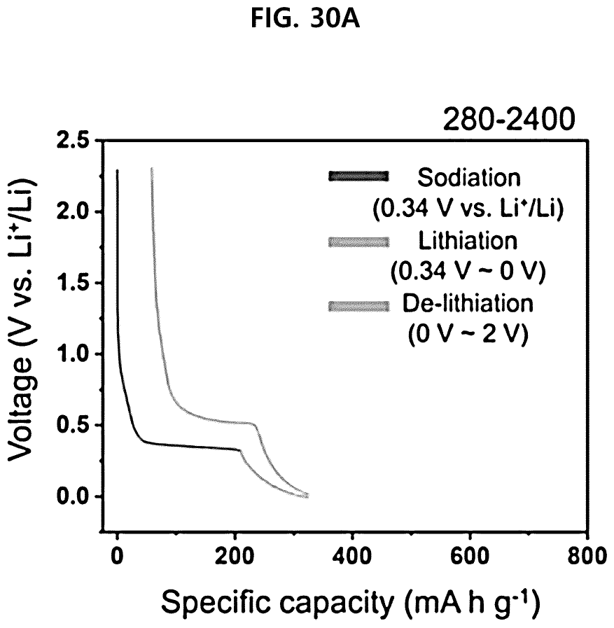

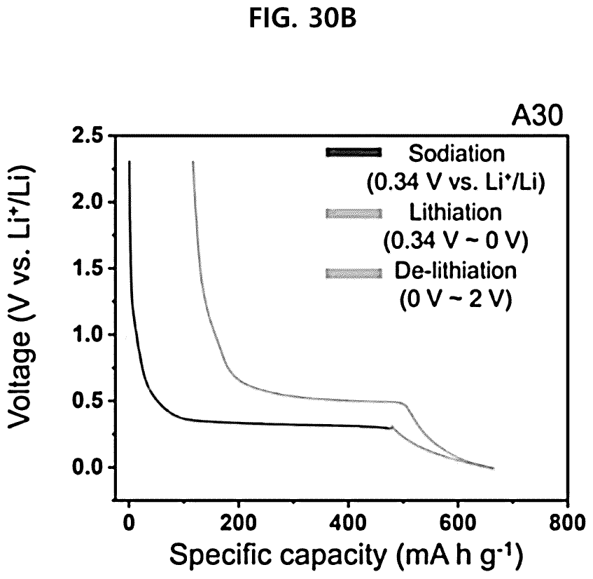

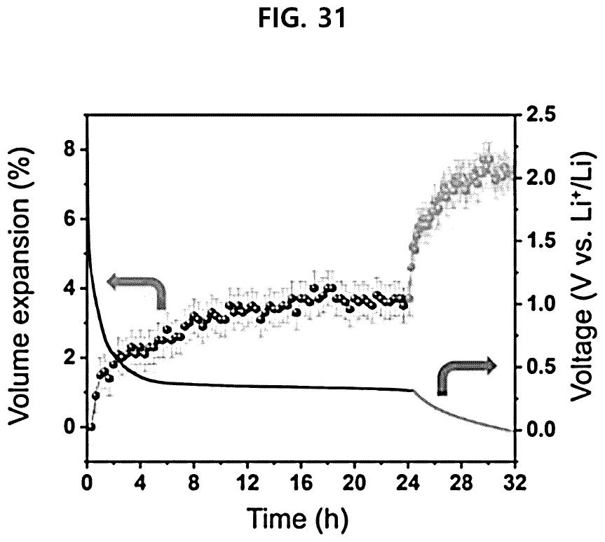

The microstructure was confirmed for A30 in the hard carbon anode prepared in preparation example 3. The results are shown in FIGS. 30 and 31. FIGS. 30A and 30B are graph showing a constant-current sodiation/lithiation profile curve of hard carbon according to an embodiment of the present disclosure (FIG. 30A: O280-2400, FIG. 30B: A30). FIG. 31 is a graph showing a volume expansion curve according to a process of sodiation/lithiation of hard carbon according to an embodiment of the present disclosure.

From FIGS. 30A and 30B, it may be confirmed that in both O280-2400 and A30 samples an additional lithium intercalation reaction occurred after complete sodiation, and the majority of the lithiation capacity was reversibly extracted during delithiation. Furthermore, the results of reversible extraction of the remaining Na from 280-2400 and A30 after the delithiation process demonstrate that the graphite lattice is almost empty even after complete sodiation. From FIG. 31, it may be confirmed that the operando volume expansion of the sodiation process is relatively low, at less than 4% compared to the volume expansion (˜7%) of the lithiation process, despite the higher SPC capacity. The low volume expansion is evidence of a poor biphasic sodium interlayer reaction and at the same time indicates the high potential of hard carbon anodes for sodium ion batteries (SIBs).

### <Experimental Example 15> Structural Index Analysis of Chemically Activated Hard Carbon

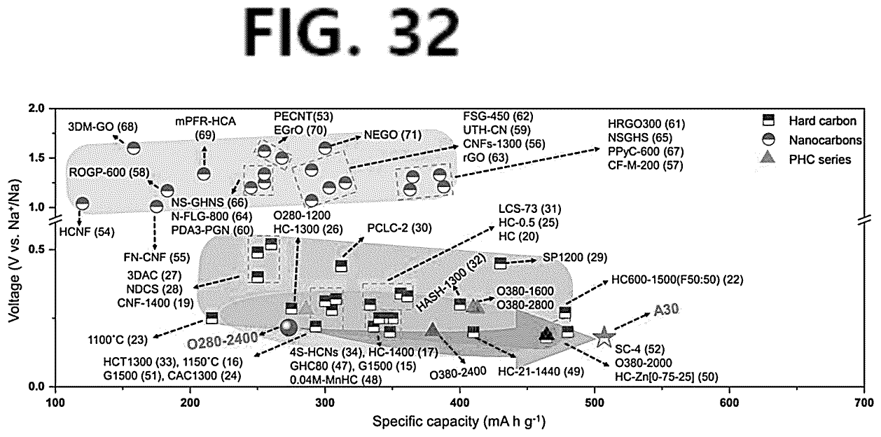

The structural index of the hard carbon was analyzed for the half cell of reference example 2 using the hard carbon prepared in preparation example 3. The results are shown in Table 5 and FIG. 32. FIG. 32 is a graph showing specific capacity and voltage of hard carbon according to an embodiment of the present disclosure.

TABLE 5

| | | Pore Volume | SPC | |
|---|---|---|---|---|
| Classification | I_{2D}/I_{G} | Ratio (%) | Factor | CCU (%) at 60° C. |
| O280-2400 | 0.76 | 36 | 0.73 | 45.69 |
| A10 | 0.48 | 38 | 0.82 | 74.72 |
| A30 | 0.45 | 41 | 0.82 | 83.89 |
| A50 | 0.54 | 43 | 0.77 | 57.85 |

On the other hand, the previously reported data indicated in FIG. 32 are shown in the literature below.
Guo, Z. et al. Investigating the superior performance of hard carbon anodes in sodium-ion compared with lithium- and potassium-ion batteries. Adv. Mater. 35 2304091 (2023).
Stevens, D. A. & Dahn, J. R. High capacity anode materials for rechargeable sodium-ion batteries. J. Electrochem. Soc. 147, 1271-1273 (2000).
Morikawa, Y., Nishimura, S., Hashimoto, R., Ohnuma, M. & Yamada, A. Mechanism of sodium storage in hard carbon: An X-ray scattering analysis. Adv. Energy Mater. 10 1903176 (2020).
Zhang, B., Ghimbeu, C. M., Laberty, C., Vix-Guterl, C. & Tarascon, J.-M. Correlation between microstructure and Na storage behavior in hard carbon. Adv. Energy Mater. 6 1501588 (2016).
Wang, Z. et al. Probing the energy storage mechanism of quasi-metallic Na in hard carbon for sodium-ion batteries. Adv. Energy Mater. 11 2003854 (2021).
Kamiyama, A. et al. MgO-template synthesis of extremely high capacity hard carbon for Na-ion battery. Angew. Chem. Int. Edit. 60, 5114-5120 (2021).
Stratford, J. M. et al. Correlating local structure and sodium storage in hard carbon anodes: insights from pair distribution function analysis and solid-state NMR. J. Am. Chem. Soc. 143, 14274-14286 (2021).
Wang, K. et al. Altering thermal transformation pathway to create closed pores in coal-derived hard carbon and boosting of Na+ plateau storage for high-performance sodium-ion battery and sodium-ion capacitor. Adv. Funct. Mater. 32, 2203725 (2022).
Xiao, L. et al. Low-defect and low-porosity hard carbon with high coulombic efficiency and high capacity for practical sodium ion battery anode. Adv. Energy Mater. 8, 1703238 (2018).
Alvin, S. et al. Revealing the intercalation mechanisms of lithium, sodium, and potassium in hard carbon. Adv. Energy. Mater. 10, 2000283 (2020).
Lu, P., Sun, Y., Xiang, H. F., Liang, X. & Yu, Y. 3D amorphous carbon with controlled porous and disordered structures as a high-rate anode material for sodium-ion batteries. Adv. Energy Mater. 8, 1702434 (2018).
Yang, T. et al. A Sustainable route from biomass byproduct okara to high content nitrogen-doped carbon sheets for efficient sodium ion batteries. Adv. Mater. 28, 539-545 (2016).
Sun, N., Liu, H. & Xu, B. Facile synthesis of high performance hard carbon anode materials for sodium ion batteries. J. Mater. Chem. A 3, 20560-20566 (2015).
Chen, H., Sun, N., Wang, Y. X., Soomro, R. A. & Xu, B. One stone two birds: Pitch assisted microcrystalline regulation and defect engineering in coal-based carbon anodes for sodium-ion batteries. Energy Storage Mater. 56, 532-541 (2023).
Chen, H., Sun, N., Zhu, Q. Z., Soomro, R. A. & Xu, B. Microcrystalline hybridization enhanced coal-based carbon anode for advanced sodium-ion batteries. Adv. Sci. 9, 2200023 (2022).
Zhu, Y., Chen, M. M., Li, Q., Yuan, C. & Wang, C. Y. A porous biomass-derived anode for high-performance sodium-ion batteries. Carbon 129, 695-701 (2018).
Li, Y., Hu, Y.-S., Titirici, M. M., Chen, L. Q. & Huang, X. J. Hard carbon microtubes made from renewable cotton as high-performance anode material for sodium-ion batteries. Adv. Energy Mater. 6, 1600659 (2016).
Bin, D. S. et al. Structural engineering of multishelled hollow carbon nanostructures for high-performance Na-ion battery Anode. Adv. Energy Mater. 8, 1800855 (2018).
Zhang, H., Zhang, W. F. & Huang, F. Q. Graphene inducing graphitization: Towards a hard carbon anode with ultrahigh initial coulombic efficiency for sodium storage. Chem. Eng. J. 434, 134503 (2022).
Zhao, J. et al. Catalytic Defect-repairing using manganese ions for hard carbon anode with high-capacity and high-initial-coulombic-efficiency in sodium-ion batteries. Adv. Energy Mater. 13, 2300444 (2023). 2
Meng, Q. et al. Tuning the closed pore structure of hard carbons with the highes Na storage capacity. ACS Energy Lett. 4, 2608-2612 (2019).
Igarashi, D. et al. New template synthesis of anomalously large capacity hard carbon for Na- and K-ion batteries. Adv. Energy Mater. 13, 2302647 (2023).
Au, H. et al. A revised mechanistic model for sodium insertion in hard carbons. Energy Environ. Sci. 13, 3469-3479 (2020).
Li, Q. et al. Sieving carbons promise practical anodes with extensible low-potential plateaus for sodium batteries. Natl. Sci. Rev. 9, nwac084 (2022).
Saroja, A. P. V. K., Muruganathan, M., Muthusamy, K., Mizuta, H. & Sundara, R. Enhanced sodium ion storage in interlayer expanded multiwall carbon nanotubes. Nano Lett. 18, 5688-5696 (2018).
Zhong, Y., Xia, X. H., Zhan, J. Y., Wang, X. L. & Tu, J. P. A CNT cocoon on sodium manganate nanotubes forming a core/branch cathode coupled with a helical carbon nanofibre anode for enhanced sodium ion batteries. J. Mater. Chem. A 4, 11207-11213 (2016).
Wang, Z. et al. Functionalized N-doped interconnected carbon nanofibers as an anode material for sodium-ion storage with excellent performance. Carbon 55, 328-334 (2013).
Yang, H., Xu, R. & Yu, Y. A facile strategy toward sodium-ion batteries with ultra-long cycle life and high initial Coulombic Efficiency: Free-standing porous carbon nanofiber film derived from bacterial cellulose. Energy Storage Mater. 22, 105-112 (2019).
Ning, M. et al. Edge Graphitized oxygen-rich carbon based on stainless steel-assisted high-energy ball milling for high-capacity and ultrafast sodium storage. Small 19, 2301975 (2023).
Yun, Y. S. et al. Crumpled graphene paper for high power sodium battery anode. Carbon 99, 658-664 (2016).
Yun, Y. S., Cho, S. Y., Kim, H., Jin, H. J. & Kang, K. Ultra-thin hollow carbon nanospheres for pseudocapacitive sodium-ion storage. Chemelectrochem 2, 359-365 (2015).
Luo, Y. et al. A conjugated plier-linked nano-spacing graphite network for sodium-ion battery. Energy Storage Mater. 39, 70-80 (2021).
Zhao, J. et al. Partially reduced holey graphene oxide as high performance anode for sodium-ion batteries. Adv. Energy Mater. 9, 1803215 (2019).
Mahmood, A. et al. Foldable and scrollable graphene paper with tuned interlayer spacing as high areal capacity anodes for sodium-ion batteries. Energy Storage Mater. 41, 395-403 (2021).
Zheng, G. et al. Ultrafast presodiation of graphene anodes for high-efficiency and high-rate sodium-ion storage. Infomat 3, 1445-1454 (2021).
Liu, J. et al. Graphitic carbon nitride (g-C3N4)-derived N-rich graphene with tuneable interlayer distance as a high-rate anode for sodium-ion batteries. Adv. Mater. 31, 1901261 (2019).
Chen, W. et al. Understanding the role of nitrogen and sulfur doping in promoting kinetics of oxygen reduction reaction and sodium ion battery performance of hollow spherical graphene. Carbon 187, 230-240 (2022).
Thangavel, R. et al. Surface enriched graphene hollow spheres towards building ultra-high power sodium-ion capacitor with long durability. Energy Storage Mater. 25, 702-713 (2020).
Luo, Z. et al. Graphene oxide templated nitrogen-doped carbon nanosheets with superior rate capability for sodium ion batteries. Carbon 122, 82-91 (2017).
Zhang, Y. et al. Diamine molecules double lock-link structured graphene oxide sheets for high-performance sodium ions storage. Energy Storage Mater. 34, 45-52 (2021).
Yu, Z. L. et al. Ion-catalyzed synthesis of microporous hard carbon embedded with expanded nanographite for enhanced lithium/sodium storage. J. Am. Chem. Soc. 138, 14915-14922 (2016).
Zhang, Y. et al. Enhanced electrochemical production and facile modification of graphite oxide for cost-effective sodium ion battery anodes. Carbon 177, 71-78 (2021).
Hu, M. et al. Ultrahigh rate sodium ion storage with nitrogen-doped expanded graphite oxide in ether-based electrolyte. J. Mater. Chem. A 6, 1582-1589 (2018).

From FIG. 32, it may be confirmed that several nanocarbons based on surface and/or bulk chemisorption mechanisms exhibited reversible capacities of 120-380 mA·h·g⁻¹ and high voltages of 1.0-1.6 V, whereas for hard carbons the higher reversible capacity of 220-480 mA·h·g⁻¹ and the lower average voltage range of 0.2-0.6 V were achieved. Furthermore, for the hard carbon according to an embodiment of the present disclosure, it showed reversible capacity and voltage similar to the previously reported hard carbon materials, and in particular, the microstructured A30 showed the highest SPC capacity among all the hard carbons.

Although the illustrative embodiments of the present disclosure have been described above in connection with the above-mentioned preferred embodiments, it is possible to make various modifications or variations without departing from the spirit and scope of the disclosure. It is therefore intended that the appended claims include such modifications or variations as fall within the spirit of the disclosure.

What is claimed is:

1. A method of manufacturing anode for sodium ion batteries, comprising:
thermally oxidizing a hard carbon precursor at a temperature of 250 to 400° C. to obtain a microstructured hard carbon; and
heating the microstructured hard carbon at a temperature of 2000 to 3000° C. to obtain polymeric hard carbons.

2. The method of manufacturing anode for sodium ion batteries of claim 1, further comprising:
performing chemical activation of the polymeric hard carbons,
wherein the activator used for chemical activation is any one selected from the group consisting of sodium hydroxide, lithium hydroxide, potassium hydroxide, rubidium hydroxide, cesium hydroxide, magnesium hydroxide, calcium hydroxide, strontium hydroxide and barium hydroxide.

3. The method of manufacturing anode for sodium ion batteries of claim 2, wherein:
the content of the activator is 10 to 50 wt % based on the weight of the polymeric hard carbons.

4. An anode for sodium ion batteries, manufactured by the method of manufacturing anode for sodium ion batteries of claim 1, comprising:
polymeric hard carbons,
wherein an SPC factor of the polymeric hard carbons represented by the following equation 1 is 0.5 to 1:
$$SPC factor = ( 1 - Pore volume ratio \times \frac{{I}_{2 D}}{{I}_{G}} ) \qquad [ Equation 1 ]$$
wherein,
the pore volume ratio is the volume ratio of closed pores, and the peak intensity ratio (I_{2D}/I_{G}) of the 2D band to the G band is the peak intensity ratio of the 2D band (near 2690 cm⁻¹) to the G band (near 1580 cm⁻¹) as measured by Raman spectroscopy.

5. The anode for sodium ion batteries of claim 4, wherein:
the pore volume ratio of the polymeric hard carbons is 10 to 80%.

6. The anode for sodium ion batteries of claim 4, wherein:
the peak intensity ratio (I_{2D}/I_{G}) of the 2D band to the G band of the polymeric hard carbons is 0.01 to 1.

7. An anode for sodium ion batteries, manufactured by the method of manufacturing anode for sodium ion batteries of claim 2, comprising:
polymeric hard carbons,
wherein the SPC factor of the polymeric hard carbons represented by the following equation 1 is 0.5 to 1:
$$SPC factor = ( 1 - Pore volume ratio \times \frac{{I}_{2 D}}{{I}_{G}} ) \qquad [ Equation 1 ]$$
wherein,
the pore volume ratio is the volume ratio of closed pores, and the peak intensity ratio (I_{2D}/I_{G}) of the 2D band to the G band is the peak intensity ratio of the 2D band (near 2690 cm⁻¹) to the G band (near 1580 cm⁻¹) as measured by Raman spectroscopy.

8. The anode for sodium ion batteries of claim 7, wherein:
the pore volume ratio of the polymeric hard carbons is 10 to 80%.

9. The anode for sodium ion batteries of claim 7, wherein:
the peak intensity ratio (I_{2D}/I_{G}) of the 2D band to the G band of the polymeric hard carbons is 0.01 to 1.

10. A sodium ion battery comprising an anode for the sodium ion batteries according to claim 4.

11. A sodium ion battery comprising an anode for the sodium ion batteries according to claim 7.
